(19) United States
(12) Patent Application Publication
(10) Pub. No.: US 2023/0006185 A1
(43) Pub. Date: Jan. 5, 2023

(54) SYSTEMS AND METHODS FOR ROLL TO ROLL DEPOSITION OF ELECTROCHEMICAL CELL COMPONENTS AND OTHER ARTICLES

(71) Applicant: Sion Power Corporation, Tucson, AZ (US)

(72) Inventors: Michael G. Laramie, Tucson, AZ (US); Dominic Weinstock, Tucson, AZ (US); Michael David Whitney, Marana, AZ (US); Jeremy H. Hartenberg, Tucson, AZ (US); Zachary E. Lawrence, Tucson, AZ (US)

(73) Assignee: Sion Power Corporation, Tucson, AZ (US)

(21) Appl. No.: 17/849,890

(22) Filed: Jun. 27, 2022

Related U.S. Application Data
(60) Provisional application No. 63/217,974, filed on Jul. 2, 2021.

(51) Int. Cl. H01M 4/04; H01M 10/04

(52) U.S. Cl. CPC H01M 4/0419; H01M 10/049; H01M 10/0404

(57) ABSTRACT

Systems and methods for the roll-to-roll deposition of electrochemical cell components and other articles are described.

### TECHNICAL FIELD

This application claims priority to U.S. Provisional Application No. 63/217,974, filed Jul. 2, 2021, which is incorporated herein by reference in its entirety.

### TECHNICAL FIELD934

Systems and methods for the roll-to-roll deposition of electrochemical cell components and other articles are described.

### SUMMARY

Systems and methods for the reel-to-reel deposition of electrochemical cell and battery components are disclosed herein. While the systems and methods find applications for electrochemical cell and/or battery components, other articles and devices may also be deposited. The subject matter of the present disclosure involves, in some cases, interrelated products, alternative solutions to a particular problem, and/or a plurality of different uses of one or more systems, methods, and/or articles.

In one aspect, a system for forming components of an electrochemical cell is described, the system comprising a plurality of nozzles comprising at least a first nozzle having a first tip, a second nozzle having a second tip, and a third nozzle having a third tip, wherein the first tip of the first nozzle, the second tip of the second nozzle, and the third tip of the third nozzle are colinear along an x-axis, a substrate positioned proximate the plurality of nozzles, wherein the first tip, the second tip, and the third tip occupy different positions along a z-axis such that each tip has a different height with respect to the substrate, and a roll-to-roll handling system proximate the substrate configured to move the substrate relative to the plurality of nozzles.

In another aspect, a method for forming components of an electrochemical cell is described, the method comprising spraying from a first nozzle a first plurality of particles onto a substrate, forming a first layer comprising the first plurality of particles on the substrate, moving the first layer from a first position to a second position, and spraying from a second nozzle a second plurality of particles onto the first layer, wherein a first tip of the first nozzle and a second tip of the second nozzle occupy different positions along a z-axis such that each tip has a different height with respect to the substrate, wherein the first and second pluralities of particles are the same or different.

Other advantages and novel features of the present disclosure will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIGS. 1A-1B are schematic cross-sectional side perspectives of a system and a method for spray depositing pluralities of particles on a substrate in a roll-to-roll system, according to some embodiments;

FIG. 2A is a schematic cross-sectional bottom perspective of a set of nozzles in which each nozzle within the set is configured to rotate about a fixed point, according to some embodiments;

FIG. 2B is cross-sectional schematic side perspective of a system for roll-to-roll deposition of pluralities of particles in which each nozzle within a set of nozzles is configured to rotate about a fixed point, according to some embodiments;

FIGS. 2C-2D are schematic illustrations of a system and a method for deposition pluralities of particles and/or layers comprising pluralities of particles onto a substrate, according to some embodiments;

FIG. 3A is a schematic diagram showing a cross sectional view of two layers comprising two separate pluralities of particles, according to some embodiments;

FIGS. 3B-3C are schematic diagrams showing cross sectional views two layers comprising pluralities of particles in which at least a portion of the plurality of particles of each layer are fused to one another, according to some embodiments;

FIG. 3D is a schematic diagram of two adjacent layers comprising two distinct pluralities of particles in which a gradient of each particle type forms moving from a bottom surface of the first layer to a top surface of the second layer, according to some embodiments;

FIG. 3E is a schematic diagram showing two adjacent layers comprising two distinct pluralities of particles including a first plurality of particles and a second plurality of particles between the top surface of the first layer and the bottom surface of the second layer, according to some embodiments;

FIG. 3F is a schematic diagram of two adjacent layers comprising two distinct pluralities of particles in which a gradient of each particle type forms moving from a surface of the first layer to the second layer and where at least some of the particles are fused to one another, according to some embodiments;

FIG. 3G is a schematic diagram of an electrochemical cell including multiple solid components prepared within a battery container, according to some embodiments;

and

FIGS. 4A-4B schematically illustrate spray deposition of a layer directly into a battery container, according to some embodiments.

### DETAILED DESCRIPTION

Systems and methods for roll-to-roll deposition of electrochemical cell and battery components are described herein. These system and methods may involve the deposition of solid particles, without the need for any liquids or solvents. In some cases, the roll-to-roll systems and methods include aerosol deposition techniques, which are described in more detail further below. It has been discovered and appreciated within the context of this disclosure that aerosol deposition may be used in a roll-to-roll process. In some embodiments, the roll-to-roll processes described herein involve the use of multiple spray nozzles that scan across a substrate. In some cases, two or more spray nozzles may move or oscillate about a fixed point in order to aerosol deposit particles onto the substrate. Advantageously, the thickness of a deposited layer can be controlled, for example, via the particle feed rate and/or by the speed of the substrate, without adjacent nozzles significantly affected the deposition of particles by other nozzles within the set of nozzles.

One challenge of such systems and methods is turbulence created by adjacent spray nozzles. However, it has been recognized and appreciated by this disclosure that, in some embodiments, staggered nozzles (e.g., connected to similar or identical feed systems) may be used to avoid turbulence issues. In some instances, the systems and methods disclosed herein may be a part of manufacturing process with multiple stations and/or multiple sets of nozzles may also be employed, and specific regions of the substrate may or may not be coated as desired by the user by controlling the arrangement and operation of the nozzles and/or the position of the substrate. The disclosed systems and methods may be used for the fabrication of battery or electrochemical cell components, such as aerosol-deposited cathodes, anodes, protective layers, electrolytes (e.g., solid electrolytes), and/or separators. However, it will be understood that this disclosure is not limited to only battery or electrochemical cell components but may be used in the fabrication of other articles or devices. Accordingly, while various embodiments may be described in the context of electrochemical cells, other applications are also described elsewhere herein, and those skilled in the art will be capable of recognizing other applications in view of the present disclosure.As mentioned above, two or more nozzles (e.g., three or more nozzles, four or more nozzles, five or more nozzles) may be used to deposit particles (e.g., solid particles, a plurality of particles). For various embodiments, multiple nozzles may be included within a set of nozzles, and each nozzle within the set may deposit a layer or portions of a layer onto a substrate (e.g., a flexible substrate). In some such embodiments, each layer may be a component of battery or electrochemical cell; however, in other such embodiments, more than one layer can make up a single battery or electrochemical cell component.

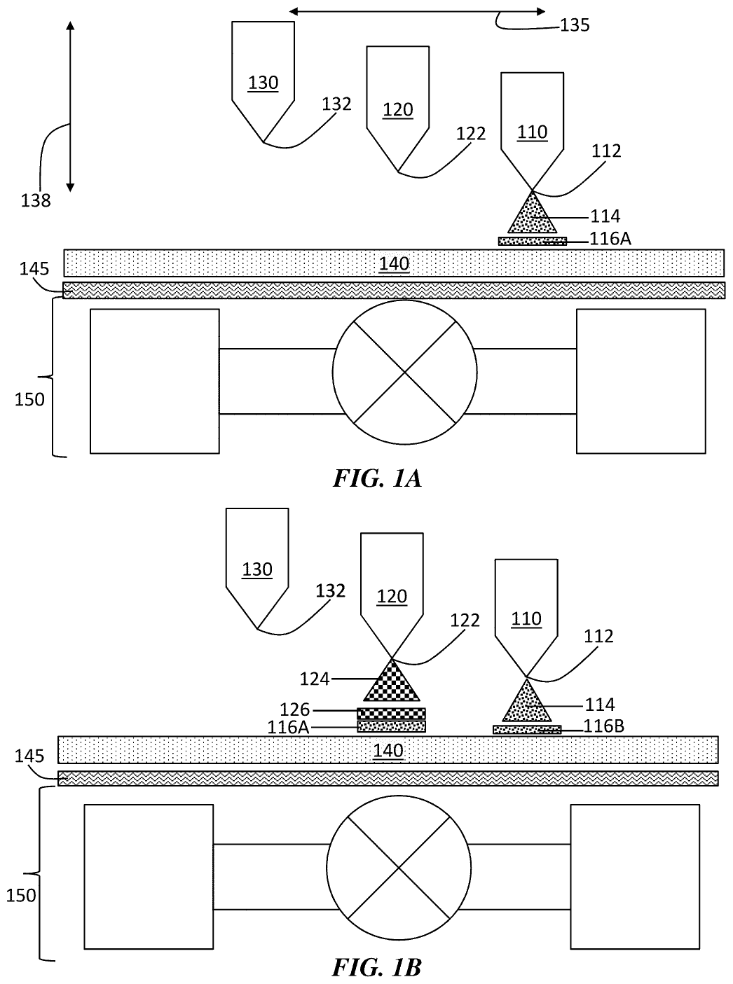

By way of illustration, FIG. 1A schematically depicts a roll-to-roll system for depositing one or more pluralities of particles as layers on a substrate (e.g., layers each comprising one or more pluralities of particles). The system includes a set of nozzles, including a first nozzle 110, a second nozzle 120, and a third nozzle 130, each with a first nozzle tip 112, a second nozzle tip 122, and a third nozzle tip 132, respectively. The system also includes a substrate 140 that may be positioned on a surface 145 of a roll-to-roll system 150. The roll-to-roll system 150 is adapted and arranged to feed the substrate 140 through the system as the set of nozzles (i.e., each nozzle within the set) deposits a layer (e.g., a layer comprising at least one plurality of particles), or portions thereof, on at least a portion of the substrate 140. For example, in FIG. 1A, a first plurality of particles 114 is deposited onto the substrate 140, forming a first layer 116A on the substrate 140.

In some embodiments, the set of nozzles is configured to reduce or minimize turbulence generated by adjacent nozzles within the set as each nozzle deposits the particles. For example, in FIG. 1A each nozzle is staggered in at least one direction relative to an adjacent nozzle. That is, first nozzle tip 112, second nozzle tip 122, and third tip 132 form a line along x-axis 135 (which may be aligned or parallel with the surface of the substrate 140) but are staggered along z-axis 138 such that the three nozzle tips are not all in line in the z-direction. In such a configuration, turbulence generated by, for example, the nozzle 130 is reduced or minimized relative to nozzle 120 (and/or nozzle 110) so that any turbulence generated by third nozzle 130 has little to no impact on deposition by either second nozzle 120 (and/or first nozzle 110).

In some embodiments, the substrate can be moved or translated from a first position to a second position in order to deposit another plurality of particles and/or another layer. For example, in FIG. 1B, the substrate 140 has been translated such that the first layer 116A moves from underneath first nozzle 110 to underneath the second nozzle 120. Here, the second nozzle 120 may deposit a second plurality of particles 124 to form a second layer 126 onto the first layer 116A without impacted the formation of a first layer 116B formed by the first nozzle 110 adjacent to the second nozzle 120. And while not shown in the figure, this process may continue with a third nozzle (e.g., third nozzle 13), a fourth nozzle, and/or a fifth nozzle, and so forth, each of which may deposit one or more pluralities of particles onto the previously formed layers.

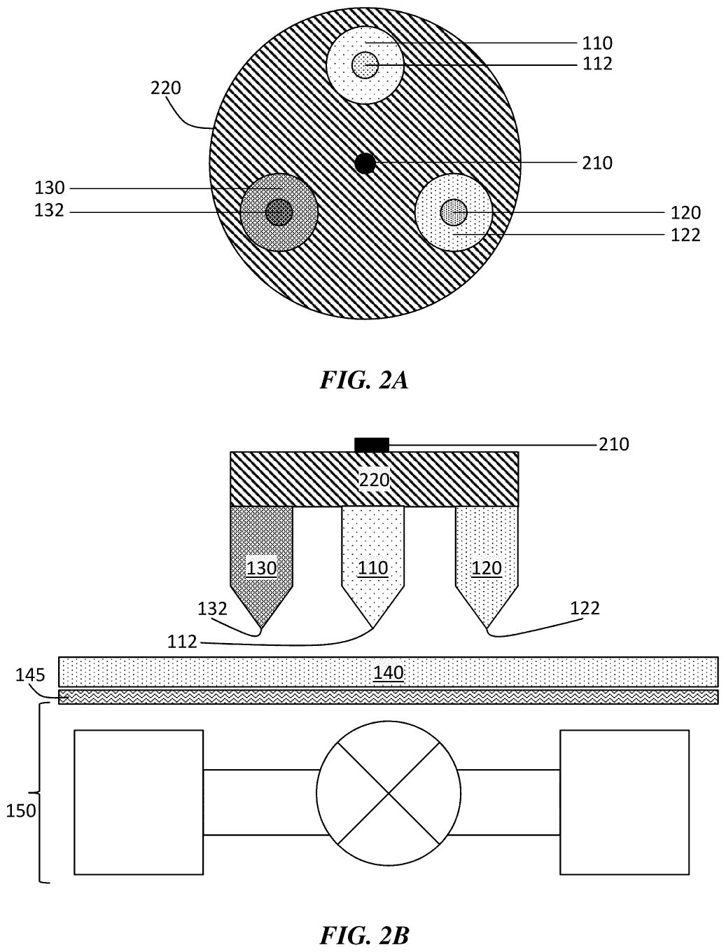

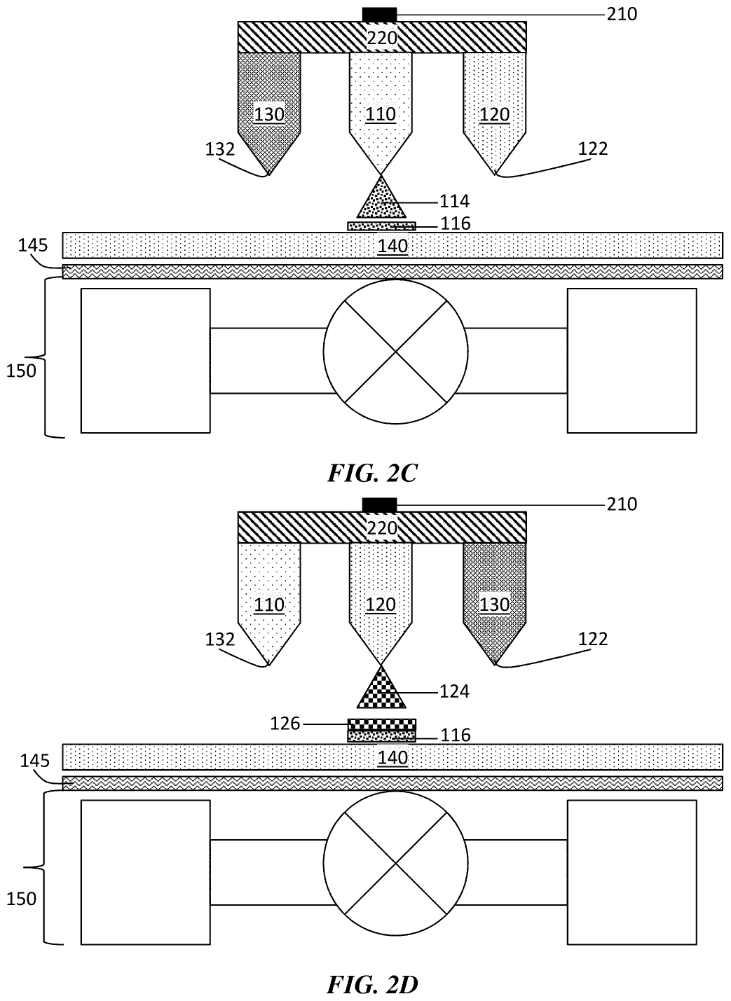

While the arrangement of nozzles shown in FIG. 1 may reduce or minimize turbulence generated by each nozzle within the set, it will be understood that other turbulence-reducing configurations are possible. For example, FIG. 2A shows another configuration for a set of nozzles. In the figure, the first nozzle 110, second nozzle 120, and third nozzle 130, are configured such that the set of nozzles rotates about a fixed point 210 within a housing 220. In such a configuration, the substrate 140 can be moved adjacent to the set of nozzles (as shown in FIG. 2B), while the set of nozzles can rotate about the fixed point 210 such that each nozzle may deposit a layer (e.g., a layer comprising a plurality of particles) or portion thereof, the set of nozzles can rotate, and another nozzle can deposit another layer onto the substrate or onto a previously deposited layer.

FIGS. 2C-2D schematically illustrates the deposition of layers in this configuration. In FIG. 2C, the first nozzle 110 deposits the plurality of particles 114 to form the first layer 116 on substrate 140. The set of nozzles may then rotate about the fixed point 210 such that the position of each nozzle within the set moves from a first position to a second position (different from the first position), as shown in FIG. 2D. The second nozzle 120 is now above the first layer 116 and can spray deposit the second plurality of particles 124 to form the second layer 126 onto the first layer 116. And while not shown in the figure, nozzles in a configuration fixed about a point may also be staggered as described above and elsewhere herein, in addition to rotating about a fixed point.

While the figures exemplify some configurations of various nozzles within a set of nozzles (e.g., staggered, configurated to rotate about a fixed point), it will be understood that other configurations are possible and may include additional nozzles (e.g., a fourth nozzle, a fifth nozzle). In some embodiments, more than one set of nozzles may be present, and each set may comprise one or more nozzles within the set.

Any suitable nozzle type may be used. In some embodiments, a set or plurality of nozzles comprises de Laval nozzle, a rocket nozzle, a conical nozzle, and/or a slit nozzle. In some embodiments, a set of nozzles includes nozzles of the same type.

In some embodiments, at least two nozzles within a set of nozzles are spaced apart sufficiently to deposit a plurality of particles while mitigating, reducing, or avoiding turbulence generated by adjacent nozzle sprays. The spacing of the nozzles within the set of nozzles may be selected to minimize turbulent flow from adjacent nozzles but spaced close enough to one another so as to allow for sequential deposition of pluralities of particles and/or layers while economizing coverage of the substrate. In some embodiments, the spacing between two adjacent nozzles is at least one maximum cross-sectional dimension (e.g., a diameter for circular or conically shaped nozzles) of at least one of the nozzles. The spacing between two nozzles can be measured from the tip of a nozzle (e.g., a first nozzle tip) to the tip of an adjacent nozzle (e.g., a second nozzle tip). In some embodiments, a spacing between a first tip of a first nozzle and a second tip of a second nozzle is at least 1 times a maximum cross-sectional dimension of the first nozzle, at least 1.2 times a maximum cross-sectional dimension of the first nozzle, at least 1.5 times a maximum cross-sectional dimension of the first nozzle, at least 1.7 times a maximum cross-sectional dimension of a first nozzle, or at least 2 times a maximum cross-sectional dimension of the first nozzle. In some embodiments, a spacing between a first tip of a first nozzle and a second tip of a second nozzle is less than or equal to 2 times a maximum cross-sectional dimension of the first nozzle, less than or equal to 1.7 times a maximum cross-sectional dimension of a first nozzle, 1.5 times a maximum cross-sectional dimension of the first nozzle, less than or equal to 1.2 times a maximum cross-sectional dimension of the first nozzle, or less than or equal to 1 times a maximum cross-sectional dimension of the first nozzle. Combinations of the above-referenced ranges are also possible (e.g., at least 1 times a maximum cross-sectional dimension of the first nozzle and less than or equal to 2 times a maximum cross-sectional dimension of the first nozzle). Other ranges are possible. In embodiments in which more than two nozzles are present, the spacing between each two adjacent nozzles may independently be in one or more of the above-referenced ranges. It should be understood that “first” and “second” are meant to represent different components and that these terms can be replaced by “third”, “fourth”, “fifth” to represent other components.

In some embodiments, at least some of the nozzles has particular spacing along an x-axis. In some embodiments, the x-axis is aligned (e.g., parallel) to a surface of the substrate. In some embodiments, the spacing of (at least some) of the nozzles along an x-axis between a first tip of a first nozzle and a second tip of a second nozzle is at least 1 times a maximum cross-sectional dimension of the first nozzle, at least 1.2 times a maximum cross-sectional dimension of the first nozzle, at least 1.5 times a maximum cross-sectional dimension of the first nozzle, at least 1.7 times a maximum cross-sectional dimension of a first nozzle, or at least 2 times a maximum cross-sectional dimension of the first nozzle. In some embodiments, the spacing of (at least some) of the nozzles along an x-axis between is less than or equal to 2 times a maximum cross-sectional dimension of the first nozzle, less than or equal to 1.7 times a maximum cross-sectional dimension of a first nozzle, 1.5 times a maximum cross-sectional dimension of the first nozzle, less than or equal to 1.2 times a maximum cross-sectional dimension of the first nozzle, or less than or equal to 1 times a maximum cross-sectional dimension of the first nozzle. Combinations of the above-referenced ranges are also possible (e.g., at least 1 times a maximum cross-sectional dimension of the first nozzle and less than or equal to 2 times a maximum cross-sectional dimension of the first nozzle). Other ranges are possible. In embodiments in which more than two nozzles are present, the spacing between each two adjacent nozzles may independently be in one or more of the above-referenced ranges. It should be understood that “first” and “second” are meant to represent different components and that these terms can be replaced by “third”, “fourth”, “fifth” to represent other components.

In some embodiments, at least some of the nozzles has particular spacing along a z-axis. In some embodiments, the z-axis is angled (e.g., perpendicular) relative to the x-axis. In some embodiments, the spacing of (at least some) of the nozzles along an z-axis between a first tip of a first nozzle and a second tip of a second nozzle is at least 1 times a maximum cross-sectional dimension of the first nozzle, at least 1.2 times a maximum cross-sectional dimension of the first nozzle, at least 1.5 times a maximum cross-sectional dimension of the first nozzle, at least 1.7 times a maximum cross-sectional dimension of a first nozzle, or at least 2 times a maximum cross-sectional dimension of the first nozzle. In some embodiments, the spacing of (at least some) of the nozzles along an z-axis between is less than or equal to 2 times a maximum cross-sectional dimension of the first nozzle, less than or equal to 1.7 times a maximum cross-sectional dimension of a first nozzle, 1.5 times a maximum cross-sectional dimension of the first nozzle, less than or equal to 1.2 times a maximum cross-sectional dimension of the first nozzle, or less than or equal to 1 times a maximum cross-sectional dimension of the first nozzle. Combinations of the above-referenced ranges are also possible (e.g., at least 1 times a maximum cross-sectional dimension of the first nozzle and less than or equal to 2 times a maximum cross-sectional dimension of the first nozzle). Other ranges are possible. In embodiments in which more than two nozzles are present, the spacing between each two adjacent nozzles may independently be in one or more of the above-referenced ranges. It should be understood that “first” and “second” are meant to represent different components and that these terms can be replaced by “third”, “fourth”, “fifth” to represent other components. And as noted above, in some embodiments, at least some of the nozzles within the set of nozzles are staggered relative to one another, such at least some of the tips of some of the nozzles are not collinear along the z-axis.

In some embodiments, the configuration of the nozzles may reduce turbulent flow generated by a nozzle within the set. In some embodiments, a spacing (e.g., a first spacing) between the first nozzle and the second nozzle is adapted and arranged to reduce turbulence between the first nozzle and the second nozzle compared to a second spacing less than the first spacing. The spacing between a second nozzle and a third nozzle (or a subsequent nozzle) may also be adapted and arranged to reduce turbulence between the second and third nozzle (or a subsequent nozzle).

The set of nozzles may be associated with one or more hoppers. As understood by those skilled in the art, a hopper is a container that holds and provides material to be feed into a nozzle for deposition (e.g., aerosol deposition). In some embodiments, the set of nozzles may share a common hopper or each nozzle within the set of nozzles may be connected or coupled with its own hopper. In some embodiments, a nozzle is connected or coupled with more than one hopper. Each hopper may include one or more particle types of the same or different material (e.g., a cathode active material, a separator material, an anode material, a protective layer material). Particle types and materials are described elsewhere herein.

The systems and methods described herein may also include a substrate (e.g., a flexible substrate) on which particles or layer(s) (i.e., pluralities of particles that may form a layer) can be deposited. In some embodiments, the substrate is a flexible substrate capable of and/or configured to flex and bend on the roll-to-roll system so as to deliver the flexible substrate to an appropriate position within the system for deposition. The substrate may be configured to release the one or more layers from the substrate after deposition. However, in other embodiments, the substrate may be incorporated into the final electrochemical cell along with the layer(s) deposited on top of it.

A variety of suitable substrates are known, and those skilled in the art in view of the present disclosure will be capable of selecting an appropriate substrate based on the desired properties of the substrate material, including its flexibility or ability to feed through the roll-to-roll system. In some embodiments, the substrate comprises a polymer, such as a poly(ester) (e.g., poly(ethylene terephthalate), such as optical-grade poly(ethylene terephthalate)). Additional non-limiting examples of suitable polymers include polyolefins, polypropylene, nylon, polyvinyl chloride, and polyethylene (which may optionally be metalized). In some embodiments, a substrate comprises a metal (e.g., a foil such as nickel foil and/or aluminum foil), a glass, or a ceramic material. In some embodiments, a substrate includes a film that may be optionally disposed on a thicker substrate material. For instance, in some embodiments, a substrate includes one or more films, such as a polymer film (e.g., a poly(ethylene terephthalate) film) and/or a metalized polymer film (using various metals such as aluminum and copper). A substrate may also include additional components such as fillers, binders, and/or surfactants.

Substrates suitable for use in combination with the systems and methods disclosed herein may have a variety of suitable thicknesses. In some embodiments, a substrate has a thickness of greater than or equal to 500 nm, greater than or equal to 750 nm, greater than or equal to 1 micron, greater than or equal to 2 microns, greater than or equal to 3 microns, greater than or equal to 4 microns, greater than or equal to 5 microns, greater than or equal to 10 microns, greater than or equal to 20 microns, greater than or equal to 25 microns, or greater than or equal to 50 microns. In some embodiments, a substrate has a thickness of less than or equal to 50 microns, less than or equal to 25 microns, less than or equal to 20 microns, less than or equal to 10 microns, less than or equal to 5 microns, less than or equal to 4 microns, less than or equal to 3 microns, less than or equal to 2 microns, less than or equal to 1 micron, less than or equal to 750 nm, or less than or equal to 500 nm. Combinations of the above-reference ranges are also possible (e.g., greater than or equal to 500 nm and less than or equal to 50 microns). Other ranges are possible.

As mentioned above, the systems and methods described herein may include a roll-to-roll handling system. The roll-to-roll handling system may be configured such that it may pass a substrate across one or more drums and/or rollers as it is being transported to or from a set of nozzles. For instance, the drums and/or rollers may be configured to translate the substrate to position for spray deposition by one (or more) of the nozzles of the set of nozzles, pause translation while spray deposition occurs, and resume translation of the substrate to another position.

In some embodiments, some or all of the roll-to-roll handling system is positioned in a vacuum chamber or other desirable environment. In some such embodiments, the pressure of the environment (e.g., the pressure of one or more gases in the environment) may be monitored and/or controlled (e.g., via vacuum, via one or more gas inlets and/or outlets) in order to facilitate the deposition of one or more pluralities of particles and/or layers.

In some embodiments, a roll-to-roll handling system further comprises a plurality of drums. The roll-to-roll handling system may be configured such that it is configured to pass the substrate over the drums as it is being transported through the system. For instance, the drums may be configured to translate the substrate through the deposition system and/or to deposition adjacent systems. It is also possible for the roll-to-roll handling system to comprise rollers that are configured to translate the substrate through the system (e.g., in conjunction with the drums and/or instead of the drums). It should also be understood that some regions of the roll-to-roll systems may lack drums and/or rollers, while other regions may comprise two or more drums and/or two or more rollers. And, in some embodiments, the rollers and/or drum may be configured to rotate to translate the substrate forwards and/or backwards.

Some drums may be capable of and/or configured to be cooled and/or heated. The cooled or heated drum may then cool or heat any portions of the substrate disposed thereon. This may be advantageous for drums positioned in environments which would otherwise be heated or cooled by their ambient environments to temperatures that are undesirable for the portions of the substrates disposed thereon, configured to be disposed thereon, and/or for particles or layers deposited thereon. For instance, the ambient environment of the region in which a drum is positioned may be heated by a process being performed therein. By way of example, a region in which a layer is deposited from a gas may be heated by the gas and/or by a solid source of the species forming the gas that is heated to form the gas. It may be undesirable for the substrate to be heated to this same temperature for a variety of reasons. For instance, heating the substrate to this same temperature may undesirably cause substrates having a low melting point to melt and/or substrates that are thermally unstable to begin to degrade. As another example, heating the substrate to this same temperature could undesirably damage a layer (or particles within a layer). As another example, it may be easier to condense the gas to form a layer onto a cooled substrate and/or a cooled substrate may assist with the formation of a layer comprising the gas that has a desirable structure and/or morphology.

Cooling and/or heating a drum may be accomplished by use of a cooling and/or heating system in thermal communication with the drum. The cooling and/or heating system may be configured to remove heat from and/or provide heat to the drum. In some embodiments, the cooling and/or heating system may be configured to maintain the drum at a set temperature, within 1° C. of a set temperature, or within a range differing from the set temperature by less than or equal to the resolution of a temperature sensor employed with the cooling and/or heating system. Cooling and/or heating a drum may be accomplished by a variety of suitable types of cooling systems, including a system circulating a cooled and/or heated fluid across one or more surfaces of the drum and/or through one or more walls of the drum. In some embodiments, a drum is heated by a heating system employing resistive heating. The cooling and/or heating system may further comprise a temperature sensor (e.g., as part of a feedback loop configured to maintain the cooling and/or heating system at a set temperature and/or within a set temperature range). Non-limiting examples of suitable temperature sensors include thermocouples and RTD sensors. Each drum in a modular lithium deposition system may be independently cooled and/or heated by different cooling and/or heating systems, or two or more (or all) drums in a system may be cooled and/or heated by a common cooling and/or heating system. Similarly, each drum may be cooled and/or heated to a different temperature, or two or more (or all) drums in may be cooled and/or heated to a common temperature.

In some embodiments, one or more features other than a drum may assist with the maintenance of a substrate at a desired temperature. As one example, a substrate may be cooled and/or heated by exposure to a gas that is at a lower or higher temperature than the substrate. For instance, the temperature of a substrate may be modified by exposure to an inert gas. In some embodiments, the inert gas may be provided concurrently with a gas provided at a temperature higher than that of the substrate. Upon exposure to the substrate, it may have a temperature lower than that of the substrate surface exposed to it or may have a temperature similar to or higher than that of the substrate surface exposed to it. In the former case, the inert gas may directly cool the substrate. In the latter, the inert gas may cool the gas it is provided with, which may reduce or eliminate any thermal damage caused to the substrate by exposure to that gas. As another example of a feature of the system that may assist with the maintenance of a substrate at a desired temperature, in some embodiments, a shield is positioned proximate the substrate (and/or a location at which the substrate is configured to be positioned, such as a drum). In some embodiments, a shield may be positioned in between the substrate or location at which the substrate is configured to be positioned (e.g., a drum) and a source of heat (e.g., a container containing a source and/or a source, such as a source of particles and/or a source of a gas). The shield may restrict the mobility of a species (e.g., a gas, a plurality of particles) positioned between the shield and the substrate and/or may tend to maintain a relatively constant atmosphere in this location. Accordingly, a cooled gas introduced into the space between the shield and the substrate may serve to cool the substrate for an appreciable period of time and/or may block the introduction of warmer species therein. In some embodiments, a cooled gas (e.g., a cooled inert gas) may be introduced into this space by one or more ports. The ports may be in fluidic communication with a source of the cooled gas and may be capable of reversibly placing the source of the cooled gas in fluidic communication with the space positioned between the substrate and the shield. It is also possible for a shield to be configured such that one or more further species may be introduced into the space between it and a substrate. Any suitable deposition technique may be used in order to deposit a plurality of particles (e.g., on to a flexible substrate) according to the methods and systems described herein. In various embodiments, the deposition technique includes an aerosol deposition technique. Aerosol deposition, as described herein, may generally result in the collision and/or elastic deformation of at least some of the plurality of particles. In some embodiments, aerosol deposition can be carried out under conditions (e.g., using a velocity) sufficient to cause fusion of at least some of the plurality of particles to at least another portion of the plurality of particles and/or to at least some of the particles of another plurality of particles. However, other deposition methods that may be suitable include, but are not limited to, sputter deposition, electron beam deposition, and physical vapor deposition.

In some embodiments, deposition (e.g., aerosol deposition) for forming a layer as described herein may be carried out such that the bulk properties of the precursor materials (e.g., solid particles) are maintained in the resulting layer (e.g., crystallinity, ion conductivity). In some embodiments, the use of aerosol deposition permits the deposition of particles formed of certain materials (e.g., ceramics) not feasible using other deposition techniques (e.g., vacuum deposition). For example, vacuum deposition (e.g., such as sputtering, e-beam evaporation) typically involves relatively high temperatures that would cause some ceramic materials to lose their bulk properties (e.g., crystallinity and/or ion conductivity) upon deposition. In other embodiments, vacuum deposition of some materials may lead to cracking of the resulting layer because such materials may have desirable mechanical properties in the crystalline state which are lost during vacuum deposition (e.g., as amorphous films) resulting in crack formation and/or mechanical stresses formed in the layer (e.g., as a result of strength and/or thermal characteristic mismatch between the substrate and the layer). In some cases, tempering of the material may not be possible after vacuum deposition for at least the aforementioned reasons. By contrast, aerosol deposition can be carried out at relatively lower temperatures, e.g., compared to certain vacuum deposition techniques, certain materials (e.g., crystalline materials) that are typically incompatible with forming certain layers (e.g., an ionically conductive layer, a protective layer) may be possible in view of the present disclosure.

As mentioned above, in some embodiments, the particles are deposited at a velocity sufficient to cause fusion of at least some of the particles. However, it should be appreciated, however, that in some embodiments, the particles are deposited at a velocity such that at least some (but not necessarily all) of the particles are not fused. In some embodiments, the velocity of the particles (e.g., for forming a first layer, a second layer, a third layer, etc.) is greater than or equal to 150 m/s, greater than or equal to 200 m/s, greater than or equal to 300 m/s, greater than or equal 400 m/s, or greater than or equal to 500 m/s, greater than or equal to 600 m/s, greater than or equal to 800 m/s, greater than or equal to 1000 m/s, or greater than or equal to 1500 m/s. In some embodiments, the velocity of the particles is less than or equal to 2000 m/s, less than or equal to 1500 m/s, less than or equal to 1000 m/s, less than or equal to 800 m/s, 600 m/s, less than or equal to 500 m/s, less than or equal to 400 m/s, less than or equal to 300 m/s, or less than or equal to 200 m/s. Combinations of the above-referenced ranges are also possible (e.g., greater than or equal to 150 m/s and less than or equal to 2000 m/s. Other ranges are possible. In embodiments in which more than one particle type is included in a layer, each particle type may be deposited at a velocity in one or more of the above-referenced ranges, for example, so as to control the extent of fusion within a layer and/or the gradient formed between particle types including within the layer or one or more adjacent layers.

In some embodiments, deposition comprises spraying the particles (e.g., via aerosol deposition) on the surface of a substrate and/or layer (e.g., a first layer, a second layer) by pressurizing a carrier gas with the particles. In some embodiments, the pressure of the carrier gas is greater than or equal to 5 psi, greater than or equal to 10 psi, greater than or equal to 20 psi, greater than or equal to 50 psi, greater than or equal to 90 psi, greater than or equal to 100 psi, greater than or equal to 150 psi, greater than or equal to 200 psi, greater than or equal to 250 psi, or greater than or equal to 300 psi. In some embodiments, the pressure of the carrier gas is less than or equal to 350 psi, less than or equal to 300 psi, less than or equal to 250 psi, less than or equal to 200 psi, less than or equal to 150 psi, less than or equal to 100 psi, less than or equal to 90 psi, less than or equal to 50 psi, less than or equal to 20 psi, or less than or equal to 10 psi. Combinations of the above-referenced ranges are also possible (e.g., greater than or equal to 5 psi and less than or equal to 350 psi). Other ranges are possible and those skilled in the art would be capable of selecting the pressure of the carrier gas based upon the teachings of this disclosure. For example, in some embodiments, the pressure of the carrier gas is such that the velocity of the particles deposited on the first layer is sufficient to fuse at least some of the particles to one another.

In some embodiments, the carrier gas (e.g., the carrier gas with the particles) is heated prior to deposition. In some embodiments, the temperature of the carrier gas is greater than or equal to 20° C., greater than or equal to 25° C., greater than or equal to 30° C., greater than or equal to 50° C., greater than or equal to 75° C., greater than or equal to 100° C., greater than or equal to 150° C., greater than or equal to 200° C., greater than or equal to 300° C., or greater than or equal to 400° C. In some embodiments, the temperature of the carrier gas is less than or equal to 500° C., less than or equal to 400° C., less than or equal to 300° C., less than or equal to 200° C., less than or equal to 150° C., less than or equal to 100° C., less than or equal to 75° C., less than or equal to 50° C., less than or equal to 30° C., or less than or equal to 20° C. Combinations of the above-referenced ranges are also possible (e.g., between 20° C. and 500° C.). Other ranges are possible.

In some embodiments, the particles are deposited under a vacuum environment (e.g., in a vacuum chamber or chamber capable of or configured to be placed under vacuum). For example, in some embodiments, the particles may be deposited in a chamber or a container in which vacuum is applied (e.g., to remove atmospheric resistance to particle flow, to permit high velocity of the particles, and/or to remove contaminants). In some embodiments, the vacuum pressure within the chamber or container is greater than or equal to 0.5 mTorr, greater than or equal to 1 mTorr, greater than or equal to 2 mTorr, greater than or equal to 5 mTorr, greater than or equal to 10 mTorr, greater than or equal to 20 mTorr, or greater than or equal to 50 mTorr. In some embodiments, the vacuum pressure within the container is less than or equal to 100 mTorr, less than or equal to 50 mTorr, less than or equal to 20 mTorr, less than or equal to 10 mTorr, less than or equal to 5 mTorr, less than or equal to 2 mTorr, or less than or equal to 1 mTorr. Combinations of the above-referenced ranges are also possible (e.g., between 0.5 mTorr and 100 mTorr). Other ranges are possible. The various components described herein (e.g., electrochemical cell components) may be formed of two or more layers, where each layer comprises a plurality of particles. For example, a first layer may comprise a first plurality of particles, and a second layer, adjacent to the first layer, may comprise a second plurality of particles. Each layer may be a particular component of the battery or a component may include two or more layers making up a single component. Depending on the desired properties of the component, each plurality of particles of a layer may be the same or different from a plurality of particles of another layer or component. Those skilled in the art in view of the teachings of the present disclosure will be capable of selecting the appropriate particle types that make up a particular plurality of particles.

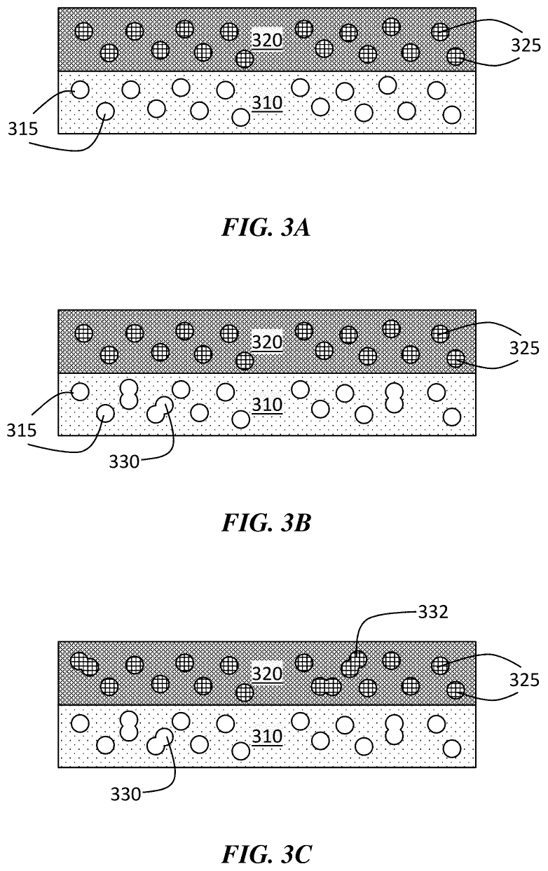

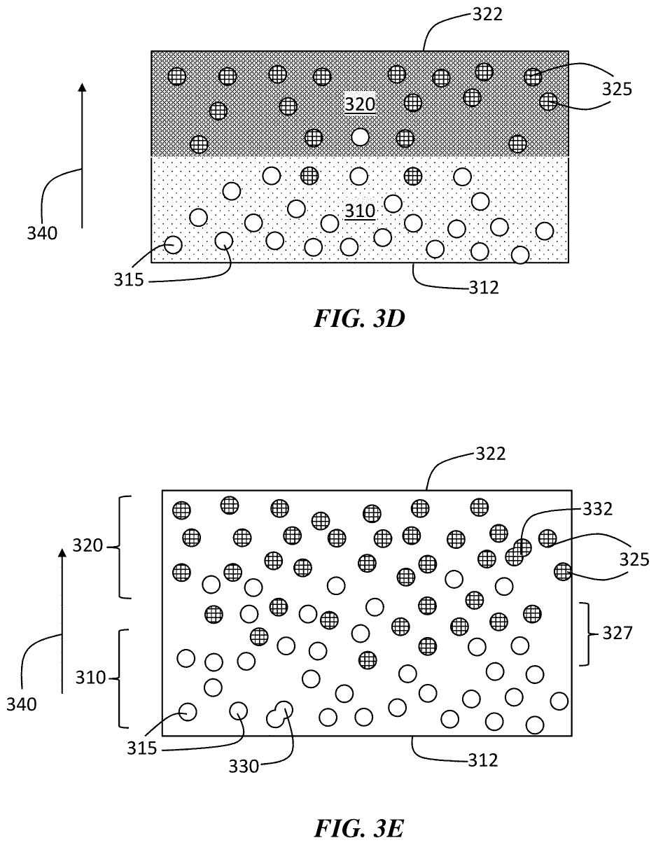

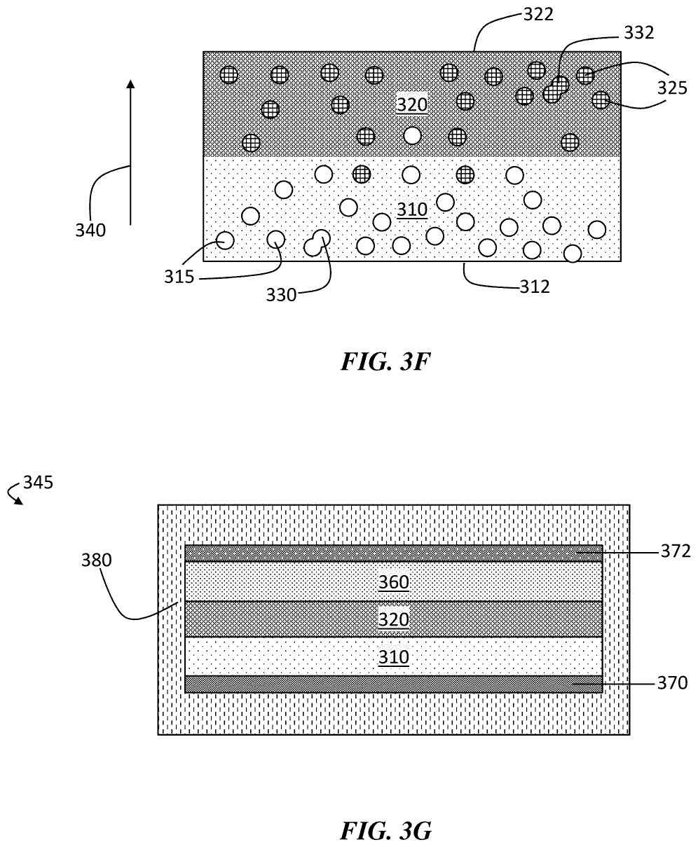

FIG. 3A schematically shows two layers each comprising distinct sets of pluralities of particles. A first layer 310 comprises a first plurality of particles 315, while a directly adjacent second layer 320 comprises a second plurality of particles 325 distinct from the first plurality of particles 315. And as noted above, it should be understood that, in some embodiments, the first plurality of particles and the second plurality of particles are not distinct.

While the figures may show two adjacent layers, it should be understood that embodiments described herein may include more than two layers (e.g., a third layer, a fourth layer, a fifth layer, additional layers) as this disclosure is not so limited. Each layer may comprise one or more pluralities of particles (that may be the same or different). In some embodiments, the particle type(s) of each layer may independently determine the properties of any one of the layers present. Particles and layer properties are described in more detail below and elsewhere herein.

It should be understood that when a portion (e.g., a component, a layer, a structure, a region) is “on”, “adjacent”, “above”, “over”, “overlying”, or “supported by” another portion, it may be directly on the portion, or an intervening portion (e.g., another component, layer, structure, region) may also be present. Similarly, when a portion is “adjacent” another portion, it can be directly adjacent the portion, or an intervening portion (e.g., layer, structure, region) may also be present. A portion that is “directly adjacent”, “directly on”, “immediately adjacent”, “in contact with”, or “directly supported by” another portion means that no intervening portion is present. It should also be understood that when a portion is referred to as being “on”, “above”, “adjacent”, “over”, “overlying”, “in contact with”, “below”, or “supported by” another portion, it may cover the entire portion or a part of the portion.

In some embodiments, at least a portion of a plurality of particles of layer or component may be fused to one another. For example, in FIG. 3B, a portion of the first plurality of particles 315 are fused, shown as fused particles 330 in the figure. It is noted that the second plurality of particles 325 are not fused in FIG. 3B. In some embodiments a layer (e.g., a first layer) comprises (at least) some fused particles while another layer (e.g., a second layer) comprises unfused particles. Of course, however, in some embodiments, more than one layer may comprise (at least some) fused particles. For example, in FIG. 3C, both the first layer 310 and the second layer 320 comprise fused particles 330 and 332, respectively.

As mentioned above, at least some of the particles of a plurality of particles may be fused to one another. The terms “fuse,” and “fused,” and “fusion” are given their typical meaning in the art and generally refers to the physical joining of two or more objects (e.g., particles) such that they form a single object. For example, in some cases, the volume occupied by a single particle (e.g., the entire volume within the outer surface of the particle) prior to fusion is substantially equal to half the volume occupied by two fused particles. Those skilled in the art will understand that the terms “fuse,” “fused,” and “fusion” do not merely refer to particles that simply contact one another at one or more surfaces, but particles wherein at least a portion of an original surface of each individual particle can no longer be discerned from the other particle. Particle fusion can be discerned using microscopy techniques, such as scanning electron microscopy (SEM).

Any one of the layers described herein may comprise a plurality of particles where at least a portion of those particles are fused together. In some embodiments, at least a portion of the first plurality of particles of the first layer and/or at least portion of the second plurality of particles of the second layer are fused to one another. When additional layers are present (e.g., a third layer, a fourth layer, a fifth layer), at least a portion of the plurality of particles of these layers may also be fused. For example, some embodiments may further comprise a third layer comprising a third plurality of particles and/or a fourth layer comprising a fourth plurality of particles, and at least a portion of the third plurality of particles and/or at least a portion of the fourth plurality of particles are fused to one another. It should also be understood that, in some embodiments, at least some particles of a layer (e.g., a first plurality of particles of a first layer) may be fused to at least some of the particles of an adjacent layer (e.g., a second plurality of particles of a second layer).

In some embodiments, unfused particles (e.g., particles within a plurality of particles that are not fused to one another or not fused to other particles) may have a particular average maximum cross-sectional transverse dimension. In some embodiments, an average maximum cross-sectional transverse dimension of unfused particles is less than or equal to 1 micron, less than 0.75 microns, less than 0.5 microns, less than 0.2 microns, or less than 0.1 microns. In some embodiments, the unfused particles have average maximum cross-sectional transverse dimension of greater than or equal to 0.05 microns, greater than or equal to 0.1 microns, greater than or equal to 0.2 microns, greater than or equal to 0.5 microns, or greater than or equal to 0.75 microns. Combinations of the above-referenced ranges are also possible (e.g., less than 1 micron and greater than or equal to 0.05 microns). Other ranges are possible. An average maximum cross-sectional transverse dimension of the particles may be determined via microscopy techniques, such as SEM.

In some embodiments, fused particles (e.g., particles within a plurality of particles that are fused to one another or are fused to other particles) may also have a particular average maximum cross-sectional transverse dimension. In some embodiments, an average maximum cross-sectional transverse dimension of fused particles is less than or equal to 5 microns, less than or equal to 3 microns, less than or equal to 2 microns, less than or equal to 1 micron, less than 0.75 microns, less than 0.5 microns, less than 0.2 microns, or less than 0.1 microns. In some embodiments, the unfused particles have average maximum cross-sectional transverse dimension of greater than or equal to 0.05 microns, greater than or equal to 0.1 microns, greater than or equal to 0.2 microns, greater than or equal to 0.5 microns, greater than or equal to 0.75 microns, greater than or equal to 1 micron, or greater than or equal to 2 microns. Combinations of the above-referenced ranges are also possible (e.g., less than 1 micron and greater than or equal to 0.05 microns). Other ranges are possible.

In some embodiments, the average maximum cross-sectional transverse dimension of fused particles within a layer are greater than the average maximum cross-sectional transverse dimension of the unfused particles within a layer. In some embodiments, the ratio of average maximum cross-sectional transverse dimensions between fused particles and unfused particles within a layer is at least 1.1:1, at least 1.5:1, at least 2:1, at least 3:1, at least 5:1, at least 8:1, at least 10:1, at least 20:1, or at least 50:1. In some embodiments, the ratio of average maximum cross-sectional transverse dimensions between fused particles and unfused particles within a layer is less than or equal to 100:1, less than or equal to 80:1, less than or equal to 60:1, less than or equal to 40:1, less than or equal to 20:1, less than or equal to 10:1, less than or equal to 5:1, or less than or equal to 2:1. Combinations of the above-referenced ranges are also possible (e.g., at least 1.5:1 and less than or equal to 100:1). Other ranges are possible.

In some embodiments, two or more sets of pluralities of particles may be deposited (e.g., via aerosol deposition) such that a gradient of the two sets of particles is formed. For example, a first plurality of particles may be deposited, while a second plurality of particles is concomitantly and/or subsequently deposited such that the amount of the first plurality of particles decreases along a direction while the second plurality of particles increases along the same direction. In some embodiments, a first plurality of particles is deposited to form a first layer, and a second plurality of particles is deposited to form a second layer on top of the first layer. A gradient of the first and second pluralities of particles may be present at the interface between the first and second layers. The gradient may include a change in particle type (e.g., ionically conductive particles, non-ionically conductive particles, particles comprising cathode active material, particles comprising a separator material), but is not limited in this manner and may also include a change in other properties, such as particle dimensions (e.g., a maximum average cross-sectional transverse dimension of a plurality of particles, a particle diameter) particle composition, particle size (e.g., an average particle volume), particle density, particle hardness, and particle coatings, without limitation. The layers described herein may also include a gradient of one or more functions and/or performance characteristics, such as ion conductivity, porosity, and specific capacity, without limitation.

As noted above, in some embodiments, the plurality of particles may be deposited (e.g., via aerosol deposition) such that a gradient (i.e., a change) of a first plurality of particles and a second plurality of particles is formed at an interface between the first layer and the second layer (e.g., an interface between a bottom surface of the first layer and a top surface of the second layer). For example, in FIG. 3D, a gradient exists between the first plurality of particles 315 and the second plurality of particles 325. That is, moving along an axis 340 extending from a bottom surface of the first layer 312 to a top surface of the second layer 322 (e.g., across the thicknesses of the layers), the amount of the first plurality of particles 315 decreases while the amount of the second plurality of particles 325 increases along at least a portion of this trajectory. Without wishing to be bound by any particular theory, it is believed that the formation of gradient of different pluralities of particles may lower the interfacial resistance between two adjacent layers relative to the interfacial resistance of two adjacent layers in the absent of a gradient, all other factors being equal. In the latter case without a gradient, the interface between the two layers is sharp and distinct; however, when a gradient of particles is formed between the two layers, the boundary between the interface is relaxed and, in some embodiments, a distinct demarcation between the two layers may not present. For example, as illustrated schematically in FIG. 3E, moving along axis 340, the particles transition from the first plurality of particles 315 to the second plurality of particles 325 within an interface 327 between the bottom surface 312 of the first layer 310 and the top surface 322 of the second layer 320. The figure illustrates that because, in some embodiments, the transition from the first plurality of particles 315 to the second plurality of particles 325 is gradual, a clear demarcation between the two layers is not present. Of course, it should be understood that in other embodiments, a clear demarcation between the layers may be present, for example, when the gradient is a step gradient.

The presence of a gradient at an interface between two layers may be particularly advantageous for forming a cathode involving the deposition of particles comprising a cathode active material, for example, by an aerosol deposition method as described herein.

As another advantage, in some embodiments a gradient may be formed with at least one plurality of particles comprising a material (e.g., a polymer) that melts when, for example, a battery containing the layers (e.g., as battery components) exceeds a threshold temperature. When this temperature is reached, the material melts to prevent or eliminate undesired shorting between two adjacent components. Additional advantages are described in more detail elsewhere herein.

In some embodiments, at least some of the plurality of particles may be fused to one another while maintaining a gradient of the pluralities of particles. For example, as schematically illustrated in FIG. 3, particles 130 of the first plurality of particles 315 are fused to one another, and particles 332 of the second plurality of particles 325 are also fused to one another. And while not shown in the figure, in some embodiments, at least a portion of the first plurality of particles may be fused to at least a portion of the second plurality of particles.

Different types and configurations of gradients are possible and not all types of configurations are shown in the figures. In some embodiments, a gradient (e.g., in one or more properties) is gradual (e.g., linear, curvilinear) between two independent portions of adjacent layers, e.g., between a surface (e.g., a top surface) of a layer (e.g., a first layer) and a surface (e.g., a bottom surface) of an adjacent layer (e.g., a second layer). In some embodiments, the gradient is present at the interface between the two layers. For example, the two adjacent layers may have an increasing amount of a second plurality of particles comprising an ionically conductive material moving from a first layer (e.g., comprising a first plurality of particles) to a second layer comprising the second plurality of particles. In some such embodiments, the first plurality of particles may comprise a material (e.g., a cathode active material) and the amount of this particle type may decrease (e.g., gradually decrease) moving from the first layer to the second layer, while the amount of the second plurality of particles may increase (e.g., gradually increase) moving from the first layer across the second layer. In another embodiment, two adjacent layers may include a step gradient in one more properties across the two layers (e.g., between a surface of a layer (e.g., a first layer) to a surface (e.g., an opposite surface) of an adjacent layer (e.g., a second layer)). In some cases, two adjacent layers, e.g., a first layer including a first plurality of particles and a second layer including a second plurality of particles, may have an abrupt transition between the first plurality of particles and the second plurality of particles. In some embodiments, a gradient is characterized by a type of function across two adjacent layers. For example, a gradient may be characterized by a sine function, a quadratic function, a periodic function, an aperiodic function, a continuous function, or a logarithmic function across the web. Other types of gradients are also possible.

In some embodiments, two or more adjacent layers (or a component comprising two or more layers) may include a gradient in one or more properties through portions of the two or more adjacent layers. In the portions of the layers where the gradient in the property is not present, the property may be substantially constant through that portion.

In some embodiments, two or more adjacent layers have a gradient in one or more properties in two or more regions of the adjacent layers. For example, an embodiment having three layers may have a first gradient in one property across the first and second layer, and a second gradient in another property across the second and third layers. The first and second gradients may be different in some embodiments (e.g., characterized by a different function along an axis from a surface of a first layer to another surface of a second layer, across a thickness of the adjacent layers), or may be the same in other embodiments. Other configurations are also possible.

In some embodiments, an amount (e.g., a density) of a first plurality of particles may increase or decrease while moving along the gradient (e.g., along an axis extending from a surface of a first layer to a surface of a second layer). In some embodiments, a density of the first plurality of particles of a first layer may decrease when moving from the first layer to a second layer, such that there is at least some of the first plurality of particles in the second layer. Conversely, in some embodiments, the density of the first plurality of particles of the first lay may increase when moving from the first layer to the second layer. Those skilled in the art in view of teaching of this disclosure will be capable of tuning the amount of a plurality of particles within a layer and/or within an adjacent layer.

As mentioned above, in some embodiments, at least some of the first plurality of particles in the first layer are present in the second layer. In some embodiments, a density of the first plurality of particles in the second layer is greater than or equal to 2.0 g/cm³, greater than or equal to 2.5 g/cm³, greater than or equal to 3.0 g/cm³, greater than or equal to 3.5 g/cm³, greater than or equal to 4.0 g/cm³, greater than or equal to 4.5 g/cm³, greater than or equal to 5.0 g/cm³, greater than or equal to 6.0 g/cm³, greater than or equal to 7.0 g/cm³, greater than or equal to 8.0 g/cm³, greater than or equal to 9.0 g/cm³, or greater than 10.0 g/cm³. In some embodiments, the density of the first plurality of particles in the second layer is less than or equal to 10.0 g/cm³, less than or equal to 9.0 g/cm³, less than or equal to 8.0 g/cm³, less than or equal to 7.0 g/cm³, less than or equal 6.0 g/cm³, less than or equal to 5.0 g/cm³, less than or equal to 4.5 g/cm³, less than or equal to 4.0 g/cm³, less than or equal to 3.5 g/cm³, less than or equal to 3.0 g/cm³, less than or equal to 2.5 g/cm³, or less than or equal 2.0 g/cm³. Combinations of the above-referenced ranges are also possible (e.g., greater than or equal to 2.0 g/cm³ and less than or equal to 10.0 g/cm³). Other ranges are possible.

In some embodiments, a density of a second plurality of particles in a first layer is greater than or equal to 0.8 g/cm³, greater than 1.0 g/cm³, greater than or equal to 1.2 g/cm³, greater than or equal to 1.5 g/cm³, greater than or equal to 1.7 g/cm³, greater than or equal to 2.0 g/cm³, greater than or equal to 2.5 g/cm³, greater than or equal to 3.0 g/cm³, greater than or equal to 3.5 g/cm³, greater than or equal to 4.0 g/cm³, greater than or equal to 4.5 g/cm³, or greater than or equal to 5.0 g/cm³. In some embodiments, the density of the second plurality of particles in the first layer is less than or equal to 5.0 g/cm³, less than or equal to 4.5 g/cm³, less than or equal to 4.0 g/cm³, less than or equal to 3.5 g/cm³, less than or equal to 3.0 g/cm³, less than or equal to 2.5 g/cm³, less than or equal to 2.0 g/cm³, less than or equal to 1.7 g/cm³, less than or equal to 1.5 g/cm³, less than or equal to 1.2 g/cm³, less than or equal to 1.0 g/cm³, or less than or equal to 0.8 g/cm³. Combinations of the above-referenced ranges are also possible (e.g., greater than or equal to 0.8 g/cm³ and less than or equal to 5.0 g/cm³). Other ranges are possible.

In some embodiments, a gradient between two or more pluralities of particles (e.g., of two or more layers) may advantageously lower the resistance between two adjacent layers relative to the two adjacent layers having no gradient of particles between the two (e.g., two layers that have a distinct or sharp interface between the layers). Without wishing to be bound by any theory, it is believed that providing a gradient of two sets of pluralities of particles each belonging to a distinct layer smoothens the transition from one particle type of a first layer to another particle type of a second layer, thereby lowering the interfacial resistance between the two adjacent layers.

In some embodiments, an interfacial resistance between a first layer (e.g., comprising a first plurality of particles) and a second layer (e.g., comprising a second plurality of particles) is less than or equal to 1Ω (ohm), less than or equal to 750 mΩ (milliohms), less than or equal to 500 mΩ, less than or equal to 250 mΩ, less than or equal to 100 mΩ, less than or equal to 50 mΩ, less than or equal to 25 mΩ, less than or equal to 10 mΩ, less than or equal to 5 mΩ, less than or equal to 1 mΩ, less than or equal to 0.5 mΩ, or less than or equal to 0.1 mΩ. In some embodiments, the interfacial resistance between a first layer and a second layer is greater than or equal to 0.1 mΩ, greater than or equal to 0.5 mΩ, greater than or equal to 1 mΩ, greater than or equal to 5 mΩ, greater than or equal to 10 mΩ, greater than or equal to 25 mΩ, greater than or equal to 50 mΩ, greater than or equal to 100 mΩ, greater than or equal to 150, mΩ, greater than or equal to 250 mΩ, greater than or equal to 500 mΩ, greater than or equal to 750 mΩ, or greater than or equal to 1Ω. Combinations of the above-referenced ranges are also possible (e.g., less than or equal to 1Ω and greater than or equal to 0.1 mΩ).

Each layer may independently comprise one or more plurality of particles, and each plurality of particles may be the same or different depending on the desired properties and/or functionality of the layer. A description of various particle types is described below. In some embodiments, a layer (e.g., a first layer, a second layer, a third layer) is a cathode and/or comprises a cathode active material. In some embodiments, a layer (e.g., a first layer, a second layer, a third layer) is an anode and/or comprises an anode active material. In some embodiments, a layer (e.g., a first layer, a second layer, a third layer) is a separator and/or comprises an ionically conductive material and/or a non-ionically conductive material. In some embodiments, a layer (e.g., a first layer, a second layer, a third layer) is an electrolyte (e.g., a solid electrolyte) and/or comprises an ionically conductive material. In some embodiments, a layer is a protective layer. Of course, other layer types are possible as this disclosure is not so limited. In some embodiments, the layer may have more than one function. For example, in some embodiments a separator layer could also be an electrolyte layer (e.g., a solid electrolyte layer).

The layers may be combined in any suitable configuration. For example, some embodiments may include a cathode layer, a separator and/or electrolyte layer, and an anode layer. However, other configurations are possible. In some embodiments, multiple anode and cathode layers may be present, separated by a separator layer. In some embodiments, a cathode layer may be adjacent to a separator layer and one or more adhesive layers, which may be adjacent to a cathode layer. Other configurations are possible and those skilled in the art in view of the teachings of the present disclosure will be capable of selecting the arrangement of the layers and selecting one or more pluralities of particles that comprise or make up the layers. In these and the other layers described herein, each layer may independently include a first plurality of particles and/or a second plurality of particles, each of which may include fused particles and/or a gradient of the first plurality of particles and the second plurality of particles, as described herein.

In some embodiments, an article (e.g., an electrochemical cell) comprises a first layer comprising a first plurality of particles, wherein at least a portion of the first plurality of particles are fused to one another; and a second layer adjacent to the first layer comprising a second plurality of particles, wherein the first and second layer are different and wherein at least a portion of the second plurality of particles are fused to one another. In some embodiments, the first layer and/or the second layer is ionically conductive. In some embodiments, the first layer is a cathode layer, and the first plurality of particles comprise a cathode active material, and the second layer is a separator layer (and the second plurality of particles may comprise a non-ionically and/or ionically conductive material). In some embodiments, the second plurality of particles are polymeric particles and/or ceramic particles. In some such embodiments, a third layer is present (e.g., adjacent the second layer) comprising a third plurality of particles. In some embodiments, this third layer may be a protective layer wherein the third plurality of particles comprises ceramic and/or polymeric particles. In other embodiments, this third layer may be an anode layer wherein the third plurality of particles comprises an anode active material (e.g., lithium metal). In other embodiments, the first layer is a current collector layer, and the first plurality of particles comprises a current collector material (e.g., metallic copper particles). In some such embodiments, the second layer is a cathode layer adjacent to the current collector layer and the second plurality of particles comprises a cathode active material. Other layer and particle configurations are possible as this disclosure is not so limited.

In some embodiments, an article (e.g., an electrochemical cell) comprises a first layer comprising a first plurality of particles, a second layer adjacent to the first layer comprising a second plurality of particles, wherein the first and second layer are different; and an interface between the first layer and the second layer, wherein the interface comprises a gradient of the first plurality of particles and the second plurality of particles, wherein the gradient of the first plurality of particles increases or decreases along an axis extending from a surface of the first layer to a surface of the second layer. In some such embodiments, the first plurality of particles comprises a cathode active material and the second plurality of particles comprises a separator material (e.g., a polymeric material, an ionically conductive material and/or a non-ionically conductive material) and a gradient of these particles in formed at or within the interface of the first layer and the second layer. In some such embodiments, a third layer is present, adjacent to the second layer, comprising a third plurality of particles, and this third plurality of particles may comprise an anode active material, and the third plurality of particles may form a gradient with the second plurality of particles comprising a separator material. Other configurations of the layers, particles, and/or gradients are possible. Each layer (e.g., comprising a first plurality of particles that may be fused and/or a second plurality of particles that may be fused) may independently have a particular thickness. In some embodiments, a layer has a thickness of greater than or equal to 100 nm, greater than or equal to 250 nm, greater than or equal to 500 nm, greater than or equal to 750 nm, greater than or equal to 1 micron, greater than or equal to 2 microns, greater than or equal to 3 microns, greater than or equal to 5 microns, greater than or equal to 10 microns, greater than or equal to 20 microns, greater than or equal to 25 microns, or greater than or equal to 50 microns. In some embodiments, a layer has a thickness of less than or equal to 50 microns, less than or equal to 25 microns, less than or equal to 20 microns, less than or equal to 10 microns, less than or equal or equal to 5 microns, less than or equal to 3 microns, less than or equal to 2 microns, less than or equal to 1 micron, less than or equal to 750 nm, less than or equal to 500 nm, less than or equal to 250 nm, or less than or equal to 100 nm. Combinations of the above-referenced ranges are also possible (e.g., greater than or equal to 100 nm and less than or equal to 10 microns). Other ranges are possible. In embodiments in which more than one layer is present, (e.g., each layer including fused particles) each layer may independently have a thickness in one or more of the ranges described above.

In some embodiments, a layer (e.g., a first layer, a second layer, a third layer, a fourth layer) may have a particular porosity. In some embodiments, the porosity of a layer (e.g., a first layer and/or a second layer) is greater than or equal to 0.1%, greater than or equal to 1%, greater than or equal to 5%, greater than or equal to 10%, greater than or equal 15%, greater than or equal to 20%, greater than or equal to 25%, or greater than or equal to 30%. In some embodiments, the porosity of a layer is less than or equal to 40%, less than or equal to 30%, less than or equal 25%, less than or equal to 20%, less than or equal to 15%, less than or equal 10%, less than or equal to 5%, less than or equal to 1%, or less than or equal to 0.1%. Combinations of the above-referenced ranges are also possible (e.g., greater than or equal to 0.1% and less than or equal to 50%). Other ranges are possible. In embodiments in which more than one layer is present, e.g., each layer including fused particles, each layer may independently have a porosity in one or more of the ranges described above. The porosity of a layer may be determined via mercury intrusion porosimetry using ASTM Standard Test D4284-07.

In some embodiments, a layer (e.g., a first layer, a second layer, a third layer) comprising a plurality of particles (e.g., a first plurality of particles and/or a second plurality of particles) includes at least some fused particles while having a particular porosity. In some embodiments, the porosity of a layer (e.g., a first layer, a second layer, a third layer) is greater than or equal to 0.1%, greater than or equal to 1%, greater than or equal to 5%, greater than or equal to 10%, greater than or equal 15%, greater than or equal to 20%, greater than or equal to 25%, or greater than or equal to 30%. In some embodiments, the porosity of a layer is less than or equal to 40%, less than or equal to 30%, less than or equal 25%, less than or equal to 20%, less than or equal to 15%, less than or equal 10%, less than or equal to 5%, less than or equal to 1%, or less than or equal to 0.1%. Combinations of the above-referenced ranges are also possible (e.g., greater than or equal to 0.1% and less than or equal to 40%). Other ranges are possible.

The layers described herein may have a particular roughness, such as an RMS (root-mean-square) surface roughness. In some embodiments a layer (e.g., a first layer and/or a second layer) has an RMS surface roughness of greater than or equal to 0.1 microns (μm), greater than or equal to 0.2 microns, greater than or equal to 0.3 microns, greater than or equal to 0.4 microns, greater than or equal to 0.5 microns, greater than or equal to 0.6 microns, greater than or equal to 0.7 microns, greater than or equal to 0.8 microns, greater than or equal to 0.9 microns, or greater than or equal to 1 micron. In some embodiments, a layer has an RMS surface roughness of less than or equal to 1 micron, less than or equal to 0.9 microns, less than or equal to 0.8 microns, less than or equal to 0.7 microns, less than or equal to 0.6 microns, less than or equal to 0.5 microns, less than or equal to 0.4 microns, less than or equal to 0.3 microns, less than or equal to 0.2 microns, or less than or equal to 0.1 microns. Combinations of the above-referenced ranges are also possible (e.g., greater than or equal to 0.1 microns and less than or equal than 1 micron). Other ranges are possible.

In some embodiments, a layer (e.g., a first layer) comprises particles (e.g., a first plurality of particles) comprising a cathode active material. That is, in some embodiments, a first layer can be a cathode and/or comprise particles of a cathode active material. Any suitable cathode active material may be used. For example, in some embodiments, the cathode active material the cathode active material is an intercalation compound comprising a lithium transition metal oxide or a lithium transition metal phosphate. Non-limiting examples include LiₓCoO₂ (e.g., Li_{1.1}CoO₂), LiₓNiO₂, LiₓMnO₂, LiₓMn₂O₄ (e.g., Li_{1.05}Mn₂O₄), LiₓCoPO₄, LiₓMnPO₄, LiCoₓNi₍₁₋ₓ₎O₂, and LiCoₓNi_{y}Mn_{(1-x-y)}O₂ (e.g., LiNi_{1/3}Mn_{1/3}Co_{1/3}O₂, LiNi_{3/5}Mn_{1/5}Co_{1/5}O₂, LiNi_{4/5}Mn_{1/10}Co_{1/10}O₂, LiNi_{1/2}Mn_{3/10}Co_{1/5}O₂). The value of x may be greater than or equal to 0 and less than or equal to 2 and the value of y may be greater than 0 and less than or equal to 2. In some embodiments, x is typically greater than or equal to 1 and less than or equal to 2 when the electrochemical device is fully discharged, and less than 1 when the electrochemical device is fully charged. In some embodiments, a fully charged electrochemical device may have a value of x that is greater than or equal to 1 and less than or equal to 1.05, greater than or equal to 1 and less than or equal to 1.1, or greater than or equal to 1 and less than or equal to 1.2. Further examples include LiₓNiPO₄, where (0<x≤1), LiMnₓNi_{y}O₄ where (x+y=2) (e.g., LiMn_{1.5}Ni_{0.5}O₄), LiNiₓCo_{y}Al_{z}O₂ where (x+y+z=1), LiFePO₄, and combinations thereof. In some embodiments, the cathode active material within a cathode comprises lithium transition metal phosphates (e.g., LiFePO₄), which can, in some embodiments, be substituted with borates and/or silicates.

In some embodiments, the cathode active material (e.g., a plurality of particles comprising the cathode active material) comprises a lithium intercalation compound (i.e., a compound that is capable of reversibly inserting lithium ions at lattice sites and/or interstitial sites). In some cases, the cathode active material comprises a layered oxide. A layered oxide generally refers to an oxide having a lamellar structure (e.g., a plurality of sheets, or layers, stacked upon each other). Non-limiting examples of suitable layered oxides include lithium cobalt oxide (LiCoO₂), lithium nickel oxide (LiNiO₂), and lithium manganese oxide (LiMnO₂). In some embodiments, the layered oxide is lithium nickel manganese cobalt oxide (LiNiₓMn_{y}Co_{z}O₂, also referred to as “NMC” or “NCM”). In some such embodiments, the sum of x, y, and z is 1. For example, a non-limiting example of a suitable NMC compound is LiNi_{1/3}Mn_{1/3}Co_{1/3}O₂. In some embodiments, a layered oxide may have the formula (Li₂MnO₃)ₓ(LiMO₂)₍₁₋ₓ₎ where M is one or more of Ni, Mn, and Co. For example, the layered oxide may be (Li₂MnO₃)_{0.25}(LiNi_{0.3}Co_{0.15}Mn_{0.55}O₂)_{0.75}. In some embodiments, the layered oxide is lithium nickel cobalt aluminum oxide (LiNiₓCo_{y}Al_{z}O₂, also referred to as “NCA”). In some such embodiments, the sum of x, y, and z is 1. For example, a non-limiting example of a suitable NCA compound is LiNi_{0.8}Co_{0.15}Al_{0.05}O₂. In some embodiments, the electroactive material is a transition metal polyanion oxide (e.g., a compound comprising a transition metal, an oxygen, and/or an anion having a charge with an absolute value greater than 1). A non-limiting example of a suitable transition metal polyanion oxide is lithium iron phosphate (LiFePO₄, also referred to as “LFP”). Another non-limiting example of a suitable transition metal polyanion oxide is lithium manganese iron phosphate (LiMnₓFe₁₋ₓPO₄, also referred to as “LMFP”). A non-limiting example of a suitable LMFP compound is LiMn_{0.8}Fe_{0.2}PO₄. In some embodiments, the electroactive material is a spinel (e.g., a compound having the structure AB₂O₄, where A can be Li, Mg, Fe, Mn, Zn, Cu, Ni, Ti, or Si, and B can be Al, Fe, Cr, Mn, or V). A non-limiting example of a suitable spinel is a lithium manganese oxide with the chemical formula LiMₓMn₂₋ₓO₄ where M is one or more of Co, Mg, Cr, Ni, Fe, Ti, and Zn. In some embodiments, x may equal 0 and the spinel may be lithium manganese oxide (LiMn₂O₄, also referred to as “LMO”). Another non-limiting example is lithium manganese nickel oxide (LiNiₓMn₂₋ₓO₄, also referred to as “LMNO”). A non-limiting example of a suitable LMNO compound is LiNi_{0.5}Mn_{1.5}O₄. In some cases, the electroactive material of the second electrode comprises Li_{1.14}Mn_{0.42}Ni_{0.25}Co_{0.29}O₂ (“HC-MNC”), lithium carbonate (Li₂CO₃), lithium carbides (e.g., Li₂C₂, Li₄C, Li₆C₂, Li₈C₃, Li₆C₃, Li₄C₃, Li₄C₅), vanadium oxides (e.g., V₂O₅, V₂O₃, V₆O₁₃), and/or vanadium phosphates (e.g., lithium vanadium phosphates, such as Li₃V₂(PO₄)₃), or any combination thereof.

In some embodiments, the cathode active material (e.g., a plurality of particles comprising the cathode active material) comprises a conversion compound and a layer comprising the cathode active material may be a lithium conversion cathode. It has been recognized that a cathode comprising a conversion compound may have a relatively large specific capacity. Without wishing to be bound by a particular theory, a relatively large specific capacity may be achieved by utilizing all possible oxidation states of a compound through a conversion reaction in which more than one electron transfer takes place per transition metal (e.g., compared to 0.1-1 electron transfer in intercalation compounds). Suitable conversion compounds include, but are not limited to, transition metal oxides (e.g., Co₃O₄), transition metal hydrides, transition metal sulfides, transition metal nitrides, and transition metal fluorides (e.g., CuF₂, FeF₂, FeF₃). A transition metal generally refers to an element whose atom has a partially filled d sub-shell (e.g., Sc, Ti, V, Cr, Mn, Fe, Co, Ni, Cu, Zn, Y, Zr, Nb, Mo, Tc, Ru, Rh, Pd, Ag, Cd, Hf, Ta, W, Re, Os, Ir, Pt, Au, Hg, Rf, Db, Sg, Bh, Hs).

In some cases, the cathode active material (e.g., a plurality of particles comprising the cathode active material) may be doped with one or more dopants to alter the electrical properties (e.g., electrical conductivity) of the cathode active material. Non-limiting examples of suitable dopants include aluminum, niobium, silver, and zirconium.

In some embodiments, the cathode active material (e.g., a plurality of particles comprising the cathode active material) may be modified by a surface coating comprising an oxide. Non-limiting examples of surface oxide coating materials include: MgO, Al₂O₃, SiO₂, TiO₂, ZnO₂, SnO₂, and ZrO₂. In some embodiments, such coatings may prevent direct contact between the cathode active material and the electrolyte, thereby suppressing side reactions.

In some embodiments, a cathode active material (e.g., a plurality of particles, such a first plurality of particles comprising the cathode active material) comprises a NCM material. In some embodiments, at least some of the particles of the plurality of particles comprising the NCM material are fused to one another. In some such embodiments, the porosity of the layer is less than or equal to 30%, 20%, 10%, 5%, or 1%. In some such embodiment, the porosity of the layer is greater than or equal 1%, 5%, 10%, 20%, or 30%. Combinations of the-above-referenced ranges are also possible (e.g., greater than or equal to 1% and less than or equal to 30%). Other ranges are possible.

In some embodiments, a layer (e.g., a first layer) comprising a cathode active material (e.g., a first plurality of particles comprising the cathode active material) may be adjacent to another layer comprising a separator material (e.g., a second plurality of particles comprising the separator material). Additionally or alternatively, the first layer may be adjacent a solid electrolyte (e.g., a second and/or third plurality of particles comprising the solid electrolyte). In some such embodiments, the adjacent layer may comprise a plurality of particles in which at least some of the plurality of particles are fused to one another and/or fused to particles of the (first) layer. In some embodiments, the separator material comprises particles comprising a polymeric material. More details regarding separators and separator materials are described below.

In some embodiments, a layer (e.g., a first layer) comprising a cathode active material (e.g., a first plurality of particles comprising the cathode active material) and one or more subsequent layers (e.g., a second layer comprising a second plurality of particles) is deposited in a container comprising a base and at least one sidewall. The second layer may include particles comprising a separator material, a solid electrolyte material, or other suitable materials as described herein. In some embodiments, at least a portion of the first layer and/or at least a portion of the second layer conforms to the at least one sidewall of the container. In some embodiments, a gradient of the first plurality of particles and the second plurality of particles is formed, wherein the first plurality of particles increases or decreases along an axis extending from a surface of the first layer to a surface of the second layer.

In some embodiments, a layer (e.g., a second layer, a third layer) comprises particles comprising an anode active material. That is, in some embodiments, a second layer or a third layer (or another layer) can be an anode and/or comprise particles of an anode active material. A variety of suitable anode active materials are possible. In some embodiments, the anode active material comprises lithium (e.g., lithium metal), such as lithium foil, lithium deposited onto a conductive substrate (e.g., a current collector) or onto a non-conductive substrate (e.g., an adhesive layer), vacuum-deposited lithium metal, spray deposited lithium, deposited lithium, and lithium alloys (e.g., lithium-aluminum alloys and lithium-tin alloys). Lithium can be provided as one film or as several films, optionally separated. Suitable lithium alloys for use in the aspects described herein can include alloys of lithium and aluminum, magnesium, silicon, indium, and/or tin. The lithium may also be provided via aerosol deposition. In some embodiments, a layer (e.g., a second layer, a third layer, a fourth layer) may comprise a plurality of particles comprising lithium (e.g., lithium metal).

In some embodiments, the lithium metal/lithium metal alloy (e.g., a plurality of particles comprising lithium metal/lithium metal alloy) may be present during only a portion of charge/discharge cycles. For example, the cell can be constructed without any lithium metal/lithium metal alloy on an anode current collector (e.g., copper), and the lithium metal/lithium metal alloy may subsequently be deposited on the anode current collector during a charging step. In some embodiments, lithium may be completely depleted after discharging such that lithium is present during only a portion of the charge/discharge cycle.

In some embodiments, the anode active material (e.g., particles comprising the anode active material) comprises greater than or equal to 50 wt % lithium, greater than or equal to 75 wt % lithium, greater than or equal to 80 wt % lithium, greater than or equal to 90 wt % lithium, greater than or equal to 95 wt % lithium, greater than or equal to 99 wt % lithium, or more. In some embodiments, the anode active material comprises less than or equal to 99 wt % lithium, less than or equal to 95 wt % lithium, less than or equal to 90 wt % lithium, less than or equal to 80 wt % lithium, less than or equal to 75 wt % lithium, less than or equal to 50 wt % lithium, or less. Combinations of the above-reference ranges are also possible (e.g., greater than or equal to 90 wt % lithium and less than or equal to 99 wt % lithium). Other ranges are possible.

In some embodiments, the anode active material (e.g., particles comprising the anode active material) is a material from which lithium ions are liberated during discharge and into which the lithium ions are integrated (e.g., intercalated) during charge. In some embodiments, the anode active material comprises a lithium intercalation compound (i.e., a compound that is capable of reversibly inserting lithium ions at lattice sites and/or interstitial sites). In some embodiments, the anode active material comprises carbon. In some cases, the anode active material is or comprises a graphitic material (e.g., graphite). A graphitic material generally refers to a 2-dimensional material that comprises a plurality of layers of graphene (i.e., layers comprising carbon atoms covalently bonded in a hexagonal lattice). Adjacent graphene layers are typically attracted to each other via van der Waals forces, although covalent bonds may also be present between one or more sheets in some cases. In some cases, the carbon-comprising anode active material is or comprises coke (e.g., petroleum coke). In some embodiments, the anode active material comprises silicon, lithium, and/or any alloys of combinations thereof. In some embodiments, the anode active material comprises lithium titanate (Li₄Ti₅O₁₂, also referred to as “LTO”), tin-cobalt oxide, or any combinations thereof.

In some embodiments, a layer (e.g., a first layer, a second layer, a third layer) may comprise an anode active material (e.g., a plurality of particles comprising the anode active material) where at least some of the particles are fused to one another. In some such embodiments, the porosity of the layer is less than or equal to 30%, 20%, 10%, 5%, or 1%. In some such embodiment, the porosity of the layer is greater than or equal 1%, 5%, 10%, 20%, or 30%. Combinations of the-above-referenced ranges are also possible (e.g., greater than or equal to 1% and less than or equal to 30%). Other ranges are possible.

In some embodiments, a layer (e.g., a first layer, a second layer, a third layer) comprising an anode active material (e.g., a plurality of particles comprising the anode active material) may be adjacent to another layer comprising a separator material (e.g., a plurality of particles comprising the separator material) and/or a solid electrolyte (e.g., a plurality of particles comprising the solid electrolyte). In such an embodiment, the adjacent layer may comprise a plurality of particles in which at least some of the plurality of particles are fused to one another and/or fused to particles of another layer. In some embodiments, the separator material comprises particles comprising a polymeric material. More details regarding separators and separator materials are described below.

In some embodiments, a layer (e.g., a first layer, a second layer, a third layer) comprising an anode active material (e.g., a first, second, or third plurality of particles comprising the anode active material) and one or more subsequent layers (e.g., a second, a third and/or fourth layer comprising a second, third and/or fourth plurality of particles, respectively) is deposited in a container comprising a base and at least one sidewall. The second, third and/or fourth layer may include particles comprising a separator material, a solid electrolyte material, a current collector material or other suitable materials as described herein. In some embodiments, at least a portion of the first, second and/or third layer and/or at least a portion of the second, third and/or fourth layer conforms to the at least one sidewall of the container. In some embodiments, a gradient of the first and/or second plurality of particles, the second and/or third plurality of particles, and/or the third and/or fourth plurality of particles is formed, wherein the at least two sets of plurality of particles increases or decreases along an axis extending from a surface of the respective layers (e.g., at an interface between the two layers).

In some embodiments, a layer and/or a plurality of particles is deposited on a substrate, such as current collector. For example, in some embodiments, a current collector is adjacent (e.g., directly adjacent) to a cathode active material and/or an anode active material such that the current collector can remove current from and/or deliver current to the electroactive layer. In some embodiments, the current collector may be deposited as a plurality of particles. For example, in some embodiments, the current collector is metallic copper and particles of copper may be deposited (e.g., via aerosol deposition) onto a surface (e.g., a surface of a battery container, a surface of a substrate). In some embodiments, the current collector may be deposited (e.g., via aerosol deposition) as a layer, adjacent to another layer (e.g., a first layer, second layer, a third layer, a cathode layer, an anode layer). In some embodiments, a layer (e.g., a first layer, a second layer, a third layer, a cathode layer, an anode layer) is deposited onto a current collector (or current collector layer). In some embodiments, a current collector is a first layer as described herein.

A wide range of current collectors are known in the art. Suitable materials for current collectors may include, for example, metals, metal foils (e.g., aluminum foil), polymer films, metallized polymer films (e.g., aluminized plastic films, such as aluminized polyester film), electrically conductive polymer films, polymer films having an electrically conductive coating, electrically conductive polymer films having an electrically conductive metal coating, and polymer films having conductive particles dispersed therein.

In some embodiments, the current collector includes one or more conductive metals such as aluminum, copper, magnesium, chromium, stainless steel and/or nickel. For example, a current collector may include a copper metal layer. Optionally, another conductive metal layer, such as magnesium or titanium, may be positioned on the copper layer. Other current collectors may include, for example, expanded metals, metal mesh, metal grids, expanded metal grids, metal wool, woven carbon fabric, woven carbon mesh, non-woven carbon mesh, and carbon felt. Furthermore, a current collector may be electrochemically inactive. In other embodiments, however, a current collector may comprise an electroactive layer. For example, a current collector may include a material which is used as an electroactive layer (e.g., as an anode or a cathode such as those described herein).

In some embodiments, a current collector (e.g., a plurality of particles comprising a current collector material) may be present without an electrode active material (e.g., a cathode active material, an anode active material) present on a surface of the current collector during at least a portion of a formation cycle of the electrode and/or during at least a portion of a charge/discharge cycle. In such an embodiment, the current collector may act as an electrode precursor in which, during formation and/or during subsequent charge/discharge cycles, an electrode active material (e.g., an anode active material such as lithium) may be formed (or deposited) on at least a portion of a surface of the current collector.

A current collector may have any suitable thickness. For instance, the thickness of a current collector may be greater than or equal to 0.1 microns, greater than or equal to 0.3 microns, greater than or equal to 0.5 microns, greater than or equal to 1 micron, greater than or equal to 3 microns, greater than or equal to 5 microns, greater than or equal to 7 microns, greater than or equal to 9 microns, greater than or equal to 10 microns, greater than or equal to 12 microns, greater than or equal to 15 microns, greater than or equal to 20 microns, greater than or equal to 25 microns, greater than or equal to 30 microns, greater than or equal to 40 microns, or greater than or equal to 50 microns. In some embodiments, the thickness of the current collector may be less than or equal to 50 microns, less than or equal to 40 microns, less than or equal to 30 microns, less than or equal to 25 microns, less than or equal to 20 microns, less than or equal to 15 microns, less than or equal to 12 microns, less than or equal to 10 microns, less than or equal to 9 microns, less than or equal to 7 microns, less than or equal to 5 microns, less than or equal to 3 microns, less than or equal to 1 micron, less than or equal to 0.5 microns, less than or equal to 0.3 microns, or less than or equal to 0.1 microns. Combinations of the above-referenced ranges are also possible (e.g., greater than or equal to 7 microns and less than or equal to 15 microns). Other ranges are possible.

In some embodiments, a layer (e.g., a first layer, a second layer) comprises particles comprising an electrolyte (e.g., a solid electrolyte). Any suitable solid or gel material capable of storing and transporting ions may be used, so long as the material can facilitate the transport of ions (e.g., lithium ions) between the anode and the cathode. The electrolyte may be electronically non-conductive to prevent short circuiting, for example, between an anode and the cathode, while, of course, being ionically conductive to facilitate the transport of ions. However, it should be understood that, for some embodiments, a battery or a cell may additionally or alternatively comprise a liquid electrolyte. Details regarding liquid electrolytes are described elsewhere herein.

In some embodiments, a layer (e.g., a first layer, a second layer, a third layer, a fourth layer) comprises particles comprising a separator material. The separator material may be an electronically and/or a non-ionically conductive material that prevents the cathode and the anode from undesired shorting, for example, due to the formation of metallic dendrites from layer to another layer. That is, the separator may be configured to inhibit (e.g., prevent) physical contact between layers (e.g., between a cathode layer and an anode layer), which could result in short circuiting of the electrochemical cell. The separator can be configured to be substantially electronically non-conductive, which can inhibit the degree to which the separator causes short circuiting of the electrochemical cell. In some embodiments, all or portions of the separator can be formed of a material with a bulk electronic resistivity of at least about 10⁴, at least about 10⁵, at least about 10¹⁰, at least about 10¹⁵, or at least about 10²⁰ Ohm-meters. Bulk electronic resistivity may be measured at room temperature (e.g., 25° C.).

In some embodiments, the separator can be ionically conductive, while in other embodiments, the separator is substantially ionically non-conductive. In some embodiments, the average ionic conductivity of the separator is greater than or equal to 10⁻⁷ S/cm, greater than or equal to 10⁻⁶ S/cm, greater than or equal to 10⁻⁵ S/cm, greater than or equal to 10⁴ S/cm, greater than or equal to 10⁻² S/cm, or greater than or equal to 10⁻¹ S/cm. In some embodiments, the average ionic conductivity of the separator may be less than or equal to 1 S/cm, less than or equal to 10⁻¹ S/cm, less than or equal to 10⁻² S/cm, less than or equal to 10⁻³ S/cm, less than or equal to 10⁴ S/cm, less than or equal to 10⁻⁵ S/cm, less than or equal to 10⁻⁶ S/cm, less than or equal to 10⁻⁷ S/cm, or less than or equal to 10⁻⁸ S/cm. Combinations of the above-referenced ranges are also possible (e.g., an average ionic conductivity of greater than or equal to 10⁻⁸ S/cm and less than or equal to about 10⁻¹ S/cm).

In some embodiments, the separator can be a solid. The separator may be porous to allow an electrolyte solvent to pass through it. In some cases, the separator does not substantially include a solvent (like in a gel), except for solvent that may pass through or reside in the pores of the separator. In other aspects, a separator may be in the form of a gel.

A separator as described herein can be made of a variety of materials. The separator may be or comprises a polymeric material in some instances, or be formed of an inorganic material (e.g., glass fiber filter papers) in other instances. Examples of suitable separator materials include, but are not limited to, polyolefins (e.g., polyethylenes, poly(butene-1), poly(n-pentene-2), polypropylene, polytetrafluoroethylene), polyamines (e.g., poly(ethylene imine) and polypropylene imine (PPI)); polyamides (e.g., polyamide (Nylon), poly(ε-caprolactam) (Nylon 6) , poly(hexamethylene adipamide) (Nylon 66)), polyimides (e.g., polyimide, polynitrile, and poly(pyromellitimide-1,4-diphenyl ether) (Kapton®) (NOMEX®) (KEVLAR®)); polyether ether ketone (PEEK); vinyl polymers (e.g., polyacrylamide, poly(2-vinyl pyridine), poly(N-vinylpyrrolidone), poly(methylcyanoacrylate), poly(ethylcyanoacrylate), poly(butylcyanoacrylate), poly(isobutylcyanoacrylate), poly(vinyl acetate), poly (vinyl alcohol), poly(vinyl chloride), poly(vinyl fluoride), poly(2-vinyl pyridine), vinyl polymer, polychlorotrifluoro ethylene, and poly(isohexylcynaoacrylate)); polyacetals; polyesters (e.g., polycarbonate, polybutylene terephthalate, polyhydroxybutyrate); polyethers (poly(ethylene oxide) (PEO), poly(propylene oxide) (PPO), poly(tetramethylene oxide) (PTMO)); vinylidene polymers (e.g., polyisobutylene, poly(methyl styrene), poly(methylmethacrylate) (PMMA), poly(vinylidene chloride), and poly(vinylidene fluoride)); polyaramides (e.g., poly(imino-1,3-phenylene iminoisophthaloyl) and poly(imino-1,4-phenylene iminoterephthaloyl)); polyheteroaromatic compounds (e.g., polybenzimidazole (PBI), polybenzobisoxazole (PBO) and polybenzobisthiazole (PBT)); polyheterocyclic compounds (e.g., polypyrrole); polyurethanes; phenolic polymers (e.g., phenol-formaldehyde); polyalkynes (e.g., polyacetylene); polydienes (e.g., 1,2-polybutadiene, cis or trans-1,4-polybutadiene); polysiloxanes (e.g., poly(dimethylsiloxane) (PDMS), poly(diethylsiloxane) (PDES), polydiphenylsiloxane (PDPS), and polymethylphenylsiloxane (PMPS)); and inorganic polymers (e.g., polyphosphazene, polyphosphonate, polysilanes, polysilazanes). In some aspects, the polymer may be selected from poly(n-pentene-2), polypropylene, polytetrafluoroethylene, polyamides (e.g., polyamide (Nylon), poly(ε-caprolactam) (Nylon 6), poly(hexamethylene adipamide) (Nylon 66)), polyimides (e.g., polynitrile, and poly(pyromellitimide-1,4-diphenyl ether) (Kapton®) (NOMEX®) (KEVLAR®)), polyether ether ketone (PEEK), and combinations thereof.

The mechanical and electronic properties (e.g., conductivity, resistivity) of these polymers are known. Accordingly, those of ordinary skill in the art can choose suitable materials based on their mechanical and/or electronic properties (e.g., ionic and/or electronic conductivity/resistivity), and/or can modify such polymers to be ionically conducting (e.g., conductive towards single ions) based on knowledge in the art, in combination with the description herein. For example, the polymer materials listed above and herein may further comprise salts, for example, lithium salts (e.g., LiSCN, LiBr, LiI, LiClO₄, LiAsF₆, LiSO₃CF₃, LiSO₃CH₃, LiBF₄, LiB(Ph)₄, LiPF₆, LiC(SO₂CF₃)₃, and LiN(SO₂CF₃)₂), to enhance ionic conductivity, if desired.

Those of ordinary skill in the art, given the present disclosure, would be capable of selecting appropriate materials for use as the separator or separator material of a plurality of particles. Relevant factors that might be considered when making such selections include the ionic conductivity of the separator material; the ability to deposit or otherwise form the separator material on or with other materials in the electrochemical cell; the flexibility of the separator material; the porosity of the separator material (e.g., overall porosity, average pore size, pore size distribution, and/or tortuosity); the compatibility of the separator material with the fabrication process used to form the electrochemical cell; the compatibility of the separator material with the electrolyte of the electrochemical cell; and/or the ability to adhere the separator material to the ion conductor material. In some embodiments, the separator material can be selected based on its ability to survive the aerosol deposition processes without mechanically failing. For example, in aspects in which relatively high velocities are used to deposit the plurality of particles (e.g., inorganic particles), the separator material can be selected or configured to withstand such deposition.

In some embodiments, a separator layer or a layer comprising a plurality of particles comprising a separator material may be adjacent to a first layer such as a cathode layer (or a layer comprising a plurality of particles comprising a cathode active material).

A separator or a separator layer may have any suitable porosity. In some embodiments, a separator or a separator layer has a porosity greater than or equal to 20%, greater than or equal to 25%, greater than or equal to 30%, greater than or equal to 40%, or greater than or equal to 50%. In some embodiments, the porosity of a separator or separator layer is less than or equal to 70%, less than or equal to 60%, less than or equal to 50%, less than or equal to 40%, less than or equal to 30%, less than or equal 25%, or less than or equal to 20%. Combinations of the above-referenced ranges are also possible (e.g., greater than or equal to 20% and less than or equal to 40%). Other ranges are possible.

In some embodiments, a layer (e.g., a second layer) comprising separator material (e.g., a second plurality of particles comprising the separator material) and optionally one or more subsequent layers (e.g., a third layer comprising a third plurality of particles) is deposited in a container comprising a base and at least one sidewall. The third and/or fourth layer may include particles comprising an anode material, a solid electrolyte material, a current collector material or other suitable materials as described herein. In some embodiments, at least a portion of the second and/or third layer and/or at least a portion of the third and/or fourth layer conforms to the at least one sidewall of the container. In some embodiments, a gradient of the second and/or third plurality of particles and the third and/or fourth plurality of particles is formed, wherein the second and/or third plurality of particles increases or decreases along an axis extending from a surface of the respective layers (e.g., at an interface between the two layers).

In some embodiments, a layer (e.g., a first layer, a second layer, a third layer, a fourth layer) and/or a plurality of particles of the layer comprises a ceramic material (e.g., glasses, glassy-ceramic materials). For example, in some embodiments a protective layer, a solid electrolyte layer, and/or a separator layer may each independently comprise particles (e.g., a first plurality of particles, a second plurality of particles, a third plurality of particles, etc.) comprising a ceramic material. Non-limiting examples of suitable ceramic materials include oxides (e.g., aluminum oxide, silicon oxide, lithium oxide), nitrides, and/or oxynitrides of aluminum, silicon, zinc, tin, vanadium, zirconium, magnesium, indium, and alloys thereof, LiXMP_{y}SZ (where x, y, and z are each integers, e.g., integers less than 32, less than or equal to 24, less than or equal 16, less than or equal to 8; and/or greater than or equal to 8, greater than or equal to 16, greater than or equal to 24); and where M=Sn, Ge, or Si) such as Li₂₂SiP₂S₁₈, Li₂₄MP₂S₁₉, or LiMP₂S₁₂ (e.g., where M=Sn, Ge, Si) and LiSiPS, garnets, crystalline or glass sulfides, phosphates, perovskites, anti-perovskites, other ion conductive inorganic materials and mixtures thereof. LiₓMP_{y}S_{z} particles can be formed, for example, using raw components Li₂S, SiS₂ and P₂S₅ (or alternatively Li₂S, Si, S and P₂S₅), for example. In an exemplary embodiment, the ceramic material is Li₂₄SiP₂S₁₉. In another exemplary embodiment, the ceramic material is Li₂₂SiP₂S₁₈.

In some aspects, a layer (e.g., a first layer, a second layer, a third layer, a fourth layer, etc.), may comprise a material including one or more of lithium nitrides, lithium nitrates (e.g., LiNO₃), lithium silicates, lithium borates (e.g., lithium bis(oxalate)borate, lithium difluoro(oxalate)borate), lithium aluminates, lithium oxalates, lithium phosphates (e.g., LiPO₃, Li₃PO₄), lithium phosphorus oxynitrides, lithium silicosulfides, lithium germanosulfides, lithium oxides (e.g., Li₂O, LiO, LiO₂, LiRO₂, where R is a rare earth metal), lithium fluorides (e.g., LIF, LiBF₄, LiAlF₄, LiPF₆, LiAsF₆, LiSbF₆, Li₂SiF₆, LiSO₃F, LiN(SO₂F)₂, LiN(SO₂CF₃)₂), lithium lanthanum oxides, lithium titanium oxides, lithium borosulfides, lithium aluminosulfides, and lithium phosphosulfides, oxy-sulfides (e.g., lithium oxy-sulfides) and combinations thereof. In some embodiments, the plurality of particles may comprise Al₂O₃, ZrO₂, SiO₂, CeO₂, and/or Al₂TiO₅ (e.g., alone or in combination with one or more of the above materials). In a particular aspect, the plurality of particles may comprise Li—Al—Ti—PO₄ (LATP). The selection of the material (e.g., ceramic) will be dependent on a number of factors including, but not limited to, the properties of the layer and adjacent layers, for example, used in an electrochemical cell.

In some embodiments, a layer (e.g., a first layer, a second layer, a third layer, a fourth layer) is a protective layer configured to protect an adjacent layer from one or more species or functions. For example, in some embodiments, the protective layer may reduce or prevent the formation of dendrites from a first layer and a second layer when the protective layer is present as an intervening layer between the first layer and the second layer. In some embodiments, the protective layer provides ion conductivity of two adjacent layers (i.e., the protective layer is in between two adjacent layers) while preventing fluidic communication between the two adjacent layers. That is, the protective layer may prevent a liquid from permeating across the protective layer while still providing ionic communication between the two adjacent layers. In some embodiments, the protective layer comprises ceramic particles and/or a polymeric material. In some embodiments, the second layer is a protective layer. In some embodiments, a third and/or a fourth layer is a protective layer.

It should be understood that the above-described particle types of layer may be used alone or in combination within a single layer or multiple layers, as this disclosure is not so limited. For example, it may be advantageous to mix a plurality of particles comprising an ionically conductive material with a plurality of non-ionically conductive particles. In some embodiments, the non-ionically conductive particles are polymeric particles where the polymeric material of the polymeric particle is configured to melt above a threshold temperature of a layer comprising both the ionically conductive particles and the polymeric particles exceeds this threshold temperature. Of course, other combinations of particles are possible. Those skilled in the art in view of the teachings of this disclosure will be capable of selecting the appropriate material for a particular particle or set of particles of a layer, either alone or in combination with other sets or plurality of particles.

The particles described herein (e.g., inorganic particles, ceramic particles, metallic particles) may have a particular hardness. The hardness of the particles may be a factor, for example, in the particles adhering to a substrate or an adjacent layer or influencing the fusion of particles in embodiments where at least some of the particles are fused to one another. The hardness of the particles may be measured by the elastic modulus (e.g., a Young's modulus) of the particles. In some embodiments, a plurality of particles (e.g., a first plurality of particles, a second plurality of particles) has an elastic greater than or equal to 5 GPa, greater than or equal 10 GPa, greater than or equal to 20 GPa, greater than or equal to 30 GPa, greater than or equal to 40 GPa, greater than or equal to 50 GPa, greater than or equal to 100 GPa, greater than or equal to 150 GPa, greater than or equal to 200 GPa, greater than or equal to 250 GPa, or greater than or equal to 300 GPa. In some embodiments, a plurality of particles has an elastic modulus of less than or equal to 300 GPa, less than or equal to 250 GPa, less than or equal to 200 GPa, less than or equal to 150 GPa, less than or equal to 100 GPa, less than or equal to 50 GPa, less than or equal to 40 GPa, less than or equal to 30 GPa, less than or equal to 20 GPa, less than or equal to 10 GPa, or less than or equal to 5 GPa. Combinations of the above-referenced ranges are also possible (e.g., greater than or equal to 5 GPa and less than or equal to 300 GPa). Other ranges are possible.

In some embodiments, a layer may be or comprise an adhesive layer. The adhesive layer may promote or facilitate adhesion of two or more adjacent layers when the adhesive layer is present as an intervening layer between the two adjacent layers. For example, in some embodiments, a half-cell may be constructed comprising an anode layer and a separate half-cell may be constructed comprising a cathode layer. In some embodiments, a separator layer and/or a solid electrolyte layer are adjacent to the anode layer and/or the cathode layer. An adhesive layer may be deposited adjacent to the anode layer and/or the cathode layer, and the anode layer and the cathode layer may be subsequently joined by placing the two adhesive layers together so that the adhesive layers are in between the anode layer and the cathode layer. In some embodiments, the adhesive layer may allow ionic and/or electronic communication between a cathode layer and an anode layer. In some embodiments, the adhesive layer comprises a polymeric material.

In some embodiments, the thickness of the adhesive layer may be between greater than or equal to 0.001 microns and less than or equal to 50 microns. In some embodiments, an adhesive layer has a thickness of greater than or equal to 0.001 microns, greater than or equal to 1 micron, greater than or equal to 2 microns, greater than or equal to 3 microns, greater than or equal to 5 microns, greater than or equal to 10 microns, greater than or equal to 20 microns, or greater than or equal to 50 microns. In some embodiments, the thickness of an adhesive layer is less than or equal to 50 microns, less than or equal to 20 microns, less than or equal to 10 microns, less than or equal to 5 microns, less than or equal to 3 microns, less than or equal to 2 microns, less than or equal to 1 micron, or less than or equal to 0.001 microns. Combinations of the above-referenced ranges are possible (e.g., greater than or equal to 2 microns and less than or equal to 20 microns). Other ranges are possible. In embodiments in which more than one adhesive layers are present, each adhesive layer may independently have a thickness in one or more of the above-referenced ranges.

In embodiments where the adhesive layer comprises a polymeric material, the adhesive layer may also include a crosslinked polymeric material and a crosslinking agent, the weight ratio of the polymeric material to the crosslinking agent may vary for a variety of reasons including, but not limited to, the functional-group content of the polymer, its molecular weight, the reactivity and functionality of the cros slinking agent, the desired rate of crosslinking, the degree of stiffness/hardness desired in the polymeric material, and the temperature at which the crosslinking reaction may occur. Non-limiting examples of ranges of weight ratios between the polymeric material and the crosslinking agent include from 100:1 to 50:1, from 20:1 to 1:1, from 10:1 to 2:1, and from 8:1 to 4:1.

The adhesive strength between two layers described herein, such as between a metal layer and an adhesive layer (e.g., an adhesive layer comprising a polymeric material), between a protective layer and a polymeric layer, between a current collector and a polymeric layer, and/or between a polymeric layer and a substrate, can be tailored as desired. To determine relative adhesion strength between two layers, a tape test can be performed. Briefly, the tape test utilizes pressure-sensitive tape to qualitatively assess the adhesion between a layer (e.g., a first layer) and a second layer (e.g., an adhesive layer). In such a test, an X-cut can be made through the first layer to the second layer. Pressure-sensitive tape can be applied over the cut area and removed. If the first layer stays on the second layer, adhesion is good. If the first layer comes off with the strip of tape, adhesion is poor. The tape test may be performed according to the standard ASTM D3359-02. In some embodiments, a strength of adhesion between a first layer and a second layer passes the tape test according to the standard ASTM D3359-02, meaning the second layer does not delaminate from the first layer during the test. In some embodiments, the tape test is performed after the two layers have been included in a cell, such as a lithium-ion cell or any other appropriate cell described herein, that has been cycled greater than or equal to 5 times, greater than or equal to 10 times, greater than or equal to 15 times, greater than or equal to 20 times, greater than or equal to 50 times, or greater than or equal to 100 times, and the two layers pass the tape test after being removed from the cell (e.g., the first layer does not delaminate from the second layer during the test).

The peel test may include measuring the adhesiveness or force required to remove a layer (e.g., first layer, a second layer, an adhesive layer) from a unit area of a surface of another layer (e.g., second layer, a third layer, an adhesive layer), which can be measured in N/m, using a tensile testing apparatus or another suitable apparatus. Such experiments can optionally be performed in the presence of a solvent (e.g., an electrolyte) or other components to determine the influence of the solvent and/or components on adhesion.

In some embodiments, the strength of adhesion between two layers may range, for example, between 100 N/m to 2000 N/m. In some embodiments, the strength of adhesion may be greater than or equal to 50 N/m, greater than or equal to 100 N/m, greater than or equal to 200 N/m, greater than or equal to 350 N/m, greater than or equal to 500 N/m, greater than or equal to 700 N/m, greater than or equal to 900 N/m, greater than or equal to 1000 N/m, greater than or equal to 1200 N/m, greater than or equal to 1400 N/m, greater than or equal to 1600 N/m, or greater than or equal to 1800 N/m. In some embodiments, the strength of adhesion may be less than or equal to 2000 N/m, less than or equal to 1500 N/m, less than or equal to 1000 N/m, less than or equal to 900 N/m, less than or equal to 700 N/m, less than or equal to 500 N/m, less than or equal to 350 N/m, less than or equal to 200 N/m, less than or equal to 100 N/m, or less than or equal to 50 N/m. Combinations of the above-referenced ranges are also possible (e.g., greater than or equal to 50 N/m and less than or equal to 2000 N/m). Other strengths of adhesion are possible.

Batteries and electrochemical cells including one or more of the components (e.g., layers, pluralities of particles) described herein may be under an applied anisotropic force. As understood in the art, an “anisotropic force” is a force that is not equal in all directions. In some embodiments, the electrochemical cells and/or the layers (e.g., a cathode layer, an anode layer) can be configured to withstand an applied anisotropic force (e.g., a force applied to enhance the morphology or performance of an electrode within the cell) while maintaining their structural integrity. The layers described herein may be a part of an electrochemical cell that is adapted and arranged such that, during at least one period of time during charge and/or discharge of the cell, an anisotropic force with a component normal to the active surface of a layer (e.g., a porous electroactive region of an electrode) within the electrochemical cell is applied to the cell.

In some such cases, the anisotropic force comprises a component normal to an active surface of an electrode (e.g., a first electrode, a second electrode) within an electrochemical cell. As used herein, the term “active surface” is used to describe a surface of an electrode at which electrochemical reactions may take place. A force with a “component normal” to a surface is given its ordinary meaning as would be understood by those of ordinary skill in the art and includes, for example, a force which at least in part exerts itself in a direction substantially perpendicular to the surface. For example, in the case of a horizontal table with an object resting on the table and affected only by gravity, the object exerts a force essentially completely normal to the surface of the table. If the object is also urged laterally across the horizontal table surface, then it exerts a force on the table which, while not completely perpendicular to the horizontal surface, includes a component normal to the table surface. Those of ordinary skill will understand other examples of these terms, especially as applied within the description of this disclosure. In the case of a curved surface (for example, a concave surface or a convex surface), the component of the anisotropic force that is normal to an active surface of an electrode may correspond to the component normal to a plane that is tangent to the curved surface at the point at which the anisotropic force is applied. The anisotropic force may be applied, in some cases, at one or more pre-determined locations, in some cases distributed over the active surface of an electrode or layer. In some embodiments, the anisotropic force is applied uniformly over the active surface of a layer.

Any of the electrochemical cell properties and/or performance metrics described herein may be achieved, alone or in combination with each other, while an anisotropic force is applied to the electrochemical cell (e.g., during charge and/or discharge of the cell). In some embodiments, the anisotropic force applied to a layer or to the electrochemical cell (e.g., during at least one period of time during charge and/or discharge of the cell) can include a component normal to an active surface of a layer (e.g., an active surface of a layer comprising lithium metal layer and/or an active surface of a porous electroactive region of layer).

In some embodiments, the component of the anisotropic force that is normal to an active surface of a layer or an electrode defines a pressure of greater than or equal to 1 kgf/cm², greater than or equal to 2 kgf/cm², greater than or equal to 4 kgf/cm², greater than or equal to 6 kgf/cm², greater than or equal to 7.5 kgf/cm², greater than or equal to 8 kgf/cm², greater than or equal to 10 kgf/cm², greater than or equal to 12 kgf/cm², greater than or equal to 14 kgf/cm², greater than or equal to 16 kgf/cm², greater than or equal to 18 kgf/cm², greater than or equal to 20 kgf/cm², greater than or equal to 22 kgf/cm², greater than or equal to 24 kgf/cm², greater than or equal to 26 kgf/cm², greater than or equal to 28 kgf/cm², greater than or equal to 30 kgf/cm², greater than or equal to 32 kgf/cm², greater than or equal to 34 kgf/cm², greater than or equal to 36 kgf/cm², greater than or equal to 38 kgf/cm², greater than or equal to 40 kgf/cm², greater than or equal to 42 kgf/cm², greater than or equal to 44 kgf/cm², greater than or equal to 46 kgf/cm², greater than or equal to 48 kgf/cm², or more. In some embodiments, the component of the anisotropic force normal to the active surface may, for example, define a pressure of less than or equal to 50 kgf/cm², less than or equal to 48 kgf/cm², less than or equal to 46 kgf/cm², less than or equal to 44 kgf/cm², less than or equal to 42 kgf/cm², less than or equal to 40 kgf/cm², less than or equal to 38 kgf/cm², less than or equal to 36 kgf/cm², less than or equal to 34 kgf/cm², less than or equal to 32 kgf/cm², less than or equal to 30 kgf/cm², less than or equal to 28 kgf/cm², less than or equal to 26 kgf/cm², less than or equal to 24 kgf/cm², less than or equal to 22 kgf/cm², less than or equal to 20 kgf/cm², less than or equal to 18 kgf/cm², less than or equal to 16 kgf/cm², less than or equal to 14 kgf/cm², less than or equal to 12 kgf/cm², less than or equal to 10 kgf/cm², less than or equal to 8 kgf/cm², less than or equal to 6 kgf/cm², less than or equal to 4 kgf/cm², less than or equal to 2 kgf/cm², or less. Combinations of the above-referenced ranges are also possible (e.g., greater than or equal to 1 kgf/cm² and less than or equal to 50 kgf/cm²). Other ranges are possible.

The anisotropic forces applied during at least a portion of charge and/or discharge may be applied using any method known in the art. In some embodiments, the force may be applied using compression springs. Forces may be applied using other elements (either inside or outside a containment structure) including, but not limited to Belleville washers, machine screws, pneumatic devices, and/or weights, among others. In some cases, cells may be pre-compressed before they are inserted into containment structures, and, upon being inserted to the containment structure, they may expand to produce a net force on the cell. Suitable methods for applying such forces are described in detail, for example, in U.S. Pat. No. 9,105,938, which is incorporated herein by reference in its entirety.

Various embodiments disclosed herein describe systems and methods for depositing plurality of particles directly on a substrate, within a battery container, or a battery container positioned on a substrate. For example, in some embodiments, in a container comprising a base and at least one sidewall, a first plurality of particles may be deposited within the container to form a first layer. A second plurality of particles may be deposited on the first layer to form a second layer such that at least a portion of the first layer and/or at least a portion of the second layer conforms to the at least one sidewall of the container. Each plurality of particles may independently comprise at least some fused particles and/or may form a gradient with another plurality of particles as described above. By contrast, certain existing systems and methods involve fabricating discrete components of electrochemical cells and combining these components later during fabrication. However, it has been appreciated within the context of the present disclosure that one or more components of a battery may be fabricated directly within a battery container, so that components do not have to be transferred later in fabrication. Advantageously, in some embodiments, several components of a battery or the entirety of a battery may be fabricated directly in a battery container using various embodiments described herein, e.g., several components of a battery or an entire battery may be fabricated from sets of pluralities of particles (e.g., solid particles).

As an example, FIG. 3G schematically illustrates an electrochemical cell 345 contained in battery container 380 that includes the first layer 310 and the second layer 320, which can be a cathode layer and a solid electrolyte layer. The electrochemical cell 345 further includes anode layer 360, cathode current collector layer 370, along with anode current collector layer 372. Of course, other arrangements of the layers are possible, as this disclosure is not limited to the configuration shown in FIG. 3G.

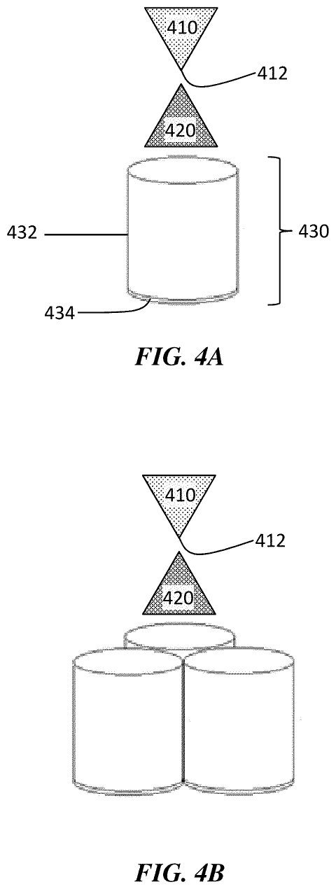

FIG. 4A schematically illustrates the deposition of a plurality of particles in a battery container. In the figure, a nozzle 410 deposits a spray 420 from a nozzle tip 412. In some embodiments, spray 420 comprises a plurality of particles (e.g., solid particles). As schematically shown in the figure, spray 420 is deposited directly into a battery container 430. The battery container 430 includes at least one sidewall 432 and at least one base 434 and spray 420 may deposit a layer adjacent to base 434 such that at least a portion of the layer conforms to sidewall 432.

In some embodiments, more than one battery container may be joined together, such that multiple batteries may be fabricated via spray deposition. For example, as shown in FIG. 4B multiple containers 430 are joined together, such that the nozzle 410 may be used for the facile deposition of spray 420 into each of battery containers 430.

Any suitable battery container may be used for depositing one or more layers and/or plurality of particles. In one embodiment, the battery container is a cylindrical container with one base and a sidewall. Additional non-limiting examples of battery containers include coin cells, pouch cells, or a battery containment vessel. Other battery containers are possible. In some embodiments, a base or a side wall of the container is or comprises a current collector, such that an electrode active material (e.g., a cathode active material, an anode active material) may be applied directly to the base and current may be collected from the base of the battery container. In some embodiments, the battery container is positioned on a substrate (e.g., a flexible substrate), which may advantageously be used to deposit pluralities of particles and/or layers in a roll-to-roll manner. In some such embodiments, the battery container can be released from the substrate (e.g., after deposition of one or more layers and/or components).

As mentioned above, the systems and methods described herein may be used to form one or more components of an electrochemical cell or battery. For example, in some embodiments, a plurality of particles is sprayed onto a substrate and a first layer is formed on the substrate comprising the first plurality of particles. The first layer may then be moved from a first position to a second position, for example, by translating the substrate using the roll-to-roll system and/or by moving one or more nozzles within a set or plurality of nozzles to a different position in order to apply another plurality of particles and/or layer. Each layer may form a component of an electrochemical cell component (e.g., a cathode layer, a separatory layer, a solid electrolyte layer, and/or an anode layer) or a component may comprise more than one layer.

In some embodiments, the layers or components (e.g., components formed via roll-to-roll deposition) can form or be part of an electrochemical cell (e.g., a rechargeable electrochemical cell). In some embodiments, the layers can be part of an electrochemical cell that is integrated into a battery (e.g., a rechargeable battery). In some embodiments, the electrochemical cells (comprising one or more layers as described herein) can be used to provide power to an electric vehicle or otherwise be incorporated into an electric vehicle. As a non-limiting example, electrochemical cells described herein can, in some cases, be used to provide power to a drive train of an electric vehicle. The vehicle may be any suitable vehicle, adapted for travel on land, sea, and/or air. For example, the vehicle may be an automobile, truck, motorcycle, boat, helicopter, airplane, and/or any other suitable type of vehicle.

While various embodiments have been described in the context of electrochemical cell and/or battery fabrication, other applications are possible. For example, in some embodiments, the disclosed systems and methods may be used to fabricate devices onto a substrate, for example, a solid-state device deposited or printed onto a substrate. For example, the substrate can be steel foil, and set of nozzles may be used to apply anti-wear, anti-corrosion, and/or thermal coatings as desired by the user. In some cases, the various embodiments described herein can be used for the simultaneous deposition of several materials onto specific locations of a substrate. Other applications are possible.

The following applications are incorporated herein by reference, in their entirety, for all purposes: U.S. Publication No. US-2007-0221265-A1 published on Sep. 27, 2007, filed as U.S. application Ser. No. 11/400,781 on Apr. 6, 2006, and entitled “RECHARGEABLE LITHIUM/WATER, LITHIUM/AIR BATTERIES”; U.S. Publication No. US-2009-0035646-A1, published on Feb. 5, 2009, filed as U.S. application Ser. No. 11/888,339 on Jul. 31, 2007, and entitled “SWELLING INHIBITION IN BATTERIES”; U.S. Publication No. US-2010-0129699-A1 published on May 17, 2010, filed as U.S. application Ser. No. 12/312,764 on Feb. 2, 2010; patented as U.S. Pat. No. 8,617,748 on Dec. 31, 2013, and entitled “SEPARATION OF ELECTROLYTES”; U.S. Publication No. US-2010-0291442-A1 published on Nov. 18, 2010, filed as U.S. application Ser. No. 12/682,011 on Jul. 30, 2010, patented as U.S. Pat. No. 8,871,387 on Oct. 28, 2014, and entitled “PRIMER FOR BATTERY ELECTRODE”; U.S. Publication No. US-2009-0200986-A1 published on Aug. 13, 2009, filed as U.S. application Ser. No. 12/069,335 on Feb. 8, 2008, patented as U.S. Pat. No. 8,264,205 on Sep. 11, 2012, and entitled “CIRCUIT FOR CHARGE AND/OR DISCHARGE PROTECTION IN AN ENERGY-STORAGE DEVICE”; U.S. Publication No. US-2007-0224502-A1 published on Sep. 27, 2007, filed as U.S. application Ser. No. 11/400,025 on Apr. 6, 2006, patented as U.S. Pat. No. 7,771,870 on Aug. 10, 2010, and entitled “ELECTRODE PROTECTION IN BOTH AQUEOUS AND NON-AQUEOUS ELECTROCHEMICAL CELLS, INCLUDING RECHARGEABLE LITHIUM BATTERIES”; U.S. Publication No. US-2008-0318128-A1 published on Dec. 25, 2008, filed as U.S. application Ser. No. 11/821,576 on Jun. 22, 2007, and entitled “LITHIUM ALLOY/SULFUR BATTERIES”; U.S. Publication No. US-2002-0055040-A1 published on May 9, 2002, filed as U.S. application Ser. No. 09/795,915 on Feb. 27, 2001, patented as U.S. Pat. No. 7,939,198 on May 10, 2011, and entitled “NOVEL COMPOSITE CATHODES, ELECTROCHEMICAL CELLS COMPRISING NOVEL COMPOSITE CATHODES, AND PROCESSES FOR FABRICATING SAME”; U.S. Publication No. US-2006-0238203-A1 published on Oct. 26, 2006, filed as U.S. application Ser. No. 11/111,262 on Apr. 20, 2005, patented as U.S. Pat. No. 7,688,075 on Mar. 30, 2010, and entitled “LITHIUM SULFUR RECHARGEABLE BATTERY FUEL GAUGE SYSTEMS AND METHODS”; U.S. Publication No. US-2008-0187663-A1 published on Aug. 7, 2008, filed as U.S. application Ser. No. 11/728,197 on Mar. 23, 2007, patented as U.S. Pat. No. 8,084,102 on Dec. 27, 2011, and entitled “METHODS FOR CO-FLASH EVAPORATION OF POLYMERIZABLE MONOMERS AND NON-POLYMERIZABLE CARRIER SOLVENT/SALT MIXTURES/SOLUTIONS”; U.S. Publication No. US-2011-0006738-A1 published on Jan. 13, 2011, filed as U.S. application Ser. No. 12/679,371 on Sep. 23, 2010, and entitled “ELECTROLYTE ADDITIVES FOR LITHIUM BATTERIES AND RELATED METHODS”; U.S. Publication No. US-2011-0008531-A1 published on Jan. 13, 2011, filed as U.S. application Ser. No. 12/811,576 on Sep. 23, 2010, patented as U.S. Pat. No. 9,034,421 on May 19, 2015, and entitled “METHODS OF FORMING ELECTRODES COMPRISING SULFUR AND POROUS MATERIAL COMPRISING CARBON”; U.S. Publication No. US-2010-0035128-A1 published on Feb. 11, 2010, filed as U.S. application Ser. No. 12/535,328 on Aug. 4, 2009, patented as U.S. Pat. No. 9,105,938 on Aug. 11, 2015, and entitled “APPLICATION OF FORCE IN ELECTROCHEMICAL CELLS”; U.S. Publication No. US-2011-0165471-A9 published on Jul. 15, 2011, filed as U.S. application Ser. No. 12/180,379 on Jul. 25, 2008, and entitled “PROTECTION OF ANODES FOR ELECTROCHEMICAL CELLS”; U.S. Publication No. US-2006-0222954-A1 published on Oct. 5, 2006, filed as U.S. application Ser. No. 11/452,445 on Jun. 13, 2006, patented as U.S. Pat. No. 8,415,054 on Apr. 9, 2013, and entitled “LITHIUM ANODES FOR ELECTROCHEMICAL CELLS”; U.S. Publication No. US-2010-0239914-A1 published on Sep. 23, 2010, filed as U.S. application Ser. No. 12/727,862 on Mar. 19, 2010, and entitled “CATHODE FOR LITHIUM BATTERY”; U.S. Publication No. US-2010-0294049-A1 published on Nov. 25, 2010, filed as U.S. application Ser. No. 12/471,095 on May 22, 2009, patented as U.S. Pat. No. 8,087,309 on Jan. 3, 2012, and entitled “HERMETIC SAMPLE HOLDER AND METHOD FOR PERFORMING MICROANALYSIS UNDER CONTROLLED ATMOSPHERE ENVIRONMENT”; U.S. Publication No. US-2011-0076560-A1 published on Mar. 31, 2011, filed as U.S. application Ser. No. 12/862,581 on Aug. 24, 2010, and entitled “ELECTROCHEMICAL CELLS COMPRISING POROUS STRUCTURES COMPRISING SULFUR”; U.S. Publication No. US-2011-0068001-A1 published on Mar. 24, 2011, filed as U.S. application Ser. No. 12/862,513 on Aug. 24, 2010, and entitled “RELEASE SYSTEM FOR ELECTROCHEMICAL CELLS”; U.S. Publication No. US-2012-0048729-A1 published on Mar. 1, 2012, filed as U.S. application Ser. No. 13/216,559 on Aug. 24, 2011, and entitled “ELECTRICALLY NON-CONDUCTIVE MATERIALS FOR ELECTROCHEMICAL CELLS”; U.S. Publication No. US-2011-0177398-A1 published on Jul. 21, 2011, filed as U.S. application Ser. No. 12/862,528 on Aug. 24, 2010, patented as U.S. Pat. No. 10,629,947 on Apr. 21, 2020, and entitled “ELECTROCHEMICAL CELL”; U.S. Publication No. US-2011-0070494-A1 published on Mar. 24, 2011, filed as U.S. application Ser. No. 12/862,563 on Aug. 24, 2010, and entitled “ELECTROCHEMICAL CELLS COMPRISING POROUS STRUCTURES COMPRISING SULFUR”; U.S. Publication No. US-2011-0070491-A1 published on Mar. 24, 2011, filed as U.S. application Ser. No. 12/862,551 on Aug. 24, 2010, and entitled “ELECTROCHEMICAL CELLS COMPRISING POROUS STRUCTURES COMPRISING SULFUR”; U.S. Publication No. US-2011-0059361-A1 published on Mar. 10, 2011, filed as U.S. application Ser. No. 12/862,576 on Aug. 24, 2010, patented as U.S. Pat. No. 9,005,809 on Apr. 14, 2015, and entitled “ELECTROCHEMICAL CELLS COMPRISING POROUS STRUCTURES COMPRISING SULFUR”; U.S. Publication No. US-2012-0052339-A1 published on Mar. 1, 2012, filed as U.S. application Ser. No. 13/216,579 on Aug. 24, 2011, and entitled “ELECTROLYTE MATERIALS FOR USE IN ELECTROCHEMICAL CELLS”; U.S. Publication No. US-2012-0070746-A1 published on Mar. 22, 2012, filed as U.S. application Ser. No. 13/240,113 on Sep. 22, 2011, and entitled “LOW ELECTROLYTE ELECTROCHEMICAL CELLS”; U.S. Publication No. US-2011-0206992-A1 published on Aug. 25, 2011, filed as U.S. application Ser. No. 13/033,419 on Feb. 23, 2011, and entitled “POROUS STRUCTURES FOR ENERGY STORAGE DEVICES”; U.S. Publication No. US-2012-0082872-A1 published on Apr. 5, 2012, filed as U.S. application Ser. No. 13/249,605 on Sep. 30, 2011, and entitled “ADDITIVE FOR ELECTROLYTES”; U.S. Publication No. US-2012-0082901-A1 published on Apr. 5, 2012, filed as U.S. application Ser. No. 13/249,632 on Sep. 30, 2011, and entitled “LITHIUM-BASED ANODE WITH IONIC LIQUID POLYMER GEL”; U.S. Publication No. US-2013-0164635-A1 published on Jun. 27, 2013, filed as U.S. application Ser. No. 13/700,696 on Mar. 6, 2013, patented as U.S. Pat. No. 9,577,243 on Feb. 21 2017, and entitled “USE OF EXPANDED GRAPHITE IN LITHIUM/SULPHUR BATTERIES”; U.S. Publication No. US-2013-0017441-A1 published on Jan. 17, 2013, filed as U.S. application Ser. No. 13/524,662 on Jun. 15, 2012, patented as U.S. Pat. No. 9,548,492 on Jan. 17, 2017, and entitled “PLATING TECHNIQUE FOR ELECTRODE”; U.S. Publication No. US-2013-0224601-A1 published on Aug. 29, 2013, filed as U.S. application Ser. No. 13/766,862 on Feb. 14, 2013, patented as U.S. Pat. No. 9,077,041 on Jul. 7, 2015, and entitled “ELECTRODE STRUCTURE FOR ELECTROCHEMICAL CELL”; U.S. Publication No. US-2013-0252103-A1 published on Sep. 26, 2013, filed as U.S. application Ser. No. 13/789,783 on Mar. 8, 2013, patented as U.S. Pat. No. 9,214,678 on Dec. 15, 2015, and entitled “POROUS SUPPORT STRUCTURES, ELECTRODES CONTAINING SAME, AND ASSOCIATED METHODS”; U.S. Publication No. US-2015-0287998-A1 published on Oct. 8, 2015, filed as U.S. application Ser. No. 14/743,304 on Jun. 18, 2015, patented as U.S. Pat. No. 9,577,267 on Feb. 21, 2017, and entitled “ELECTRODE STRUCTURE AND METHOD FOR MAKING SAME”; U.S. Publication No. US-2013-0095380-A1 published on Apr. 18, 2013, filed as U.S. application Ser. No. 13/644,933 on Oct. 4, 2012, patented as U.S. Pat. No. 8,936,870 on Jan. 20, 2015, and entitled “ELECTRODE STRUCTURE AND METHOD FOR MAKING THE SAME”; U.S. Publication No. US-2012-0052397-A1 published on Mar. 1, 2012, filed as U.S. application Ser. No. 13/216,538 on Aug. 24, 2011, patented as U.S. Pat. No. 9,853,287 on Dec. 26, 2017, and entitled “ELECTROLYTE MATERIALS FOR USE IN ELECTROCHEMICAL CELLS”; U.S. Publication No. US-2014-0123477-A1 published on May 8, 2014, filed as U.S. application Ser. No. 14/069,698 on Nov. 1, 2013, patented as U.S. Pat. No. 9,005,311 on Apr. 14, 2015, and entitled “ELECTRODE ACTIVE SURFACE PRETREATMENT”; U.S. Publication No. US-2014-0193723-A1 published on Jul. 10, 2014, filed as U.S. application Ser. No. 14/150,156 on Jan. 8, 2014, patented as U.S. Pat. No. 9,559,348 on Jan. 31, 2017, and entitled “CONDUCTIVITY CONTROL IN ELECTROCHEMICAL CELLS”; U.S. Publication No. US-2014-0255780-A1 published on Sep. 11, 2014, filed as U.S. application Ser. No. 14/197,782 on Mar. 5, 2014, patented as U.S. Pat. No. 9,490,478 on Nov. 8, 2016, and entitled “ELECTROCHEMICAL CELLS COMPRISING FIBRIL MATERIALS”; U.S. Publication No. US-2014-0272594-A1 published on Sep. 18 2014, filed as U.S. application Ser. No. 13/833,377 on Mar. 15, 2013, and entitled “PROTECTIVE STRUCTURES FOR ELECTRODES”; U.S. Publication No. US-2014-0272597-A1 published on Sep. 18, 2014, filed as U.S. application Ser. No. 14/209,274 on Mar. 13, 2014, patented as U.S. Pat. No. 9,728,768 on Aug. 8, 2017, and entitled “PROTECTED ELECTRODE STRUCTURES AND METHODS”; U.S. Publication No. US-2015-0280277-A1 published on Oct. 1, 2015, filed as U.S. application Ser. No. 14/668,102 on Mar. 25, 2015, patented as U.S. Pat. No. 9,755,268 on Sep. 5, 2017, and entitled “GEL ELECTROLYTES AND ELECTRODES”; U.S. Publication No. US-2015-0180037-A1 published on Jun. 25, 2015, filed as U.S. application Ser. No. 14/576,570 on Dec. 19, 2014, patented as U.S. Pat. No. 10,020,512 on Jul. 10, 2018, and entitled “POLYMER FOR USE AS PROTECTIVE LAYERS AND OTHER COMPONENTS IN ELECTROCHEMICAL CELLS”; U.S. Publication No. US-2015-0349310-A1 published on Dec. 3, 2015, filed as U.S. application Ser. No. 14/723,132 on May 27, 2015, patented as U.S. Pat. No. 9,735,411 on Aug. 15, 2017, and entitled “POLYMER FOR USE AS PROTECTIVE LAYERS AND OTHER COMPONENTS IN ELECTROCHEMICAL CELLS”; U.S. Publication No. US-2014-0272595-A1 published on Sep. 18, 2014, filed as U.S. application Ser. No. 14/203,802 on Mar. 11, 2014, and entitled “COMPOSITIONS FOR USE AS PROTECTIVE LAYERS AND OTHER COMPONENTS IN ELECTROCHEMICAL CELLS”; U.S. Publication No. US-2019-0006699-A1 published on Jan. 3, 2019, filed as U.S. application Ser. No. 15/727,438 on Oct. 6, 2017, and entitled “PRESSURE AND/OR TEMPERATURE MANAGEMENT IN ELECTROCHEMICAL SYSTEMS”; U.S. Publication No. US-2014-0193713-A1 published on Jul. 10, 2014, filed as U.S. application Ser. No. 14/150,196 on Jan. 8, 2014, patented as U.S. Pat. No. 9,531,009 on Dec. 27, 2016, and entitled “PASSIVATION OF ELECTRODES IN ELECTROCHEMICAL CELLS”; U.S. Publication No. US-2014-0127577-A1 published on May 8, 2014, filed as U.S. applicaton Ser. No. 14/068,333 on Oct. 31, 2013, patented as U.S. Pat. No. 10,243,202 on Mar. 26, 2019, and entitled “POLYMERS FOR USE AS PROTECTIVE LAYERS AND OTHER COMPONENTS IN ELECTROCHEMICAL CELLS”; U.S. Publication No. US-2015-0318539-A1 published on Nov. 5, 2015, filed as U.S. applicaton Ser. No. 14/700,258 on Apr. 30, 2015, patented as U.S. Pat. No. 9,711,784 on Jul. 18, 2017, and entitled “ELECTRODE FABRICATION METHODS AND ASSOCIATED SYSTEMS AND ARTICLES”; U.S. Publication No. US-2014-0272565-A1 published on Sep. 18, 2014, filed as U.S. applicaton Ser. No. 14/209,396 on Mar. 13, 2014, patented as U.S. Pat. No. 10,862,105 on Dec. 8, 2020 and entitled “PROTECTED ELECTRODE STRUCTURES”; U.S. Publication No. US-2015-0010804-A1 published on Jan. 8, 2015, filed as U.S. applicaton Ser. No. 14/323,269 on Jul. 3, 2014, patented as U.S. Pat. No. 9,994,959 on Jun. 12, 2018, and entitled “CERAMIC/POLYMER MATRIX FOR ELECTRODE PROTECTION IN ELECTROCHEMICAL CELLS, INCLUDING RECHARGEABLE LITHIUM BATTERIES”; U.S. Publication No. US-2015-0162586-A1 published on Jun. 11, 2015, filed as U.S. applicaton Ser. No. 14/561,305 on Dec. 5, 2014, and entitled “NEW SEPARATOR”; U.S. Publication No. US-2015-0044517-A1 published on Feb. 12, 2015, filed as U.S. applicaton Ser. No. 14/455,230 on Aug. 8, 2014, patented as U.S. Pat. No. 10,020,479 on Jul. 10, 2018, and entitled “SELF-HEALING ELECTRODE PROTECTION IN ELECTROCHEMICAL CELLS”; U.S. Publication No. US-2015-0236322-A1 published on Aug. 20, 2015, filed as U.S. application Ser. No. 14/184,037 on Feb. 19, 2014, patented as U.S. Pat. No. 10,490,796 on Nov. 26, 2019, and entitled “ELECTRODE PROTECTION USING ELECTROLYTE-INHIBITING ION CONDUCTOR”; U.S. Publication No. US-2015-0236320-A1 published on Aug. 20, 2015, filed as U.S. applicaton Ser. No. 14/624/641 on Feb. 18, 2015, patented as U.S. Pat. No. 9,653,750 on May 16, 2017, and entitled “ELECTRODE PROTECTION USING A COMPOSITE COMPRISING AN ELECTROLYTE-INHIBITING ION CONDUCTOR”; U.S. Publication No. US-2016-0118638-A1 published on Apr. 28, 2016, filed as U.S. applicaton Ser. No. 14/921,381 on Oct. 23, 2015, and entitled “COMPOSITIONS FOR USE AS PROTECTIVE LAYERS AND OTHER COMPONENTS IN ELECTROCHEMICAL CELLS”; U.S. Publication No. US-2016-0118651-A1 published on Apr. 28, 2016, filed as U.S. applicaton Ser. No. 14/918,672 on Oct. 21, 2015, and entitled “ION-CONDUCTIVE COMPOSITE FOR ELECTROCHEMICAL CELLS”; U.S. Publication No. US-2016-0072132-A1 published on Mar. 10, 2016, filed as U.S. applicaton Ser. No. 14/848/659 on Sep. 9, 2015, and entitled “PROTECTIVE LAYERS IN LITHIUM-ION ELECTROCHEMICAL CELLS AND ASSOCIATED ELECTRODES AND METHODS”; U.S. Publication No. US-2018-0138542-A1 published on May 17, 2018, filed as U.S. applicaton Ser. No. 15/567,534 on Oct. 18, 2017, patented as U.S. Pat. No. 10,847,833 on Nov. 24, 2020 and entitled “GLASS-CERAMIC ELECTROLYTES FOR LITHIUM-SULFUR BATTERIES”; U.S. Publication No. US-2016-0344067-A1 published on Nov. 24, 2016, filed as U.S. application Ser. No. 15/160,191 on May 20, 2016, patented as U.S. Pat. No. 10,461,372 on Oct. 29, 2019, and entitled “PROTECTIVE LAYERS FOR ELECTROCHEMICAL CELLS”; U.S. Publication No. US-2020-0099108-A1 published on Mar. 26, 2020, filed as U.S. applicaton Ser. No. 16/587,939 on Sep. 30, 2019, and entitled “PROTECTIVE LAYERS FOR ELECTROCHEMICAL CELLS”; U.S. Publication No. US-2017-0141385-A1 published on May 18, 2017, filed as U.S. applicaton Ser. No. 15/343,890 on Nov. 4, 2016, and entitled “LAYER COMPOSITE AND ELECTRODE HAVING A SMOOTH SURFACE, AND ASSOCIATED METHODS”; U.S. Publication No. US-2017-0141442-A1 published on May 18, 2017, filed as U.S. applicaton Ser. No. 15/349,140 on Nov. 11, 2016, and entitled “ADDITIVES FOR ELECTROCHEMICAL CELLS”; patented as U.S. Pat. No. 10/320,031 on Jun. 11, 2019, and entitled “ADDITIVES FOR ELECTROCHEMICAL CELLS”; U.S. Publication No. US-2017-0149086-A1 published on May 25, 2017, filed as U.S. applicaton Ser. No. 15/343,635 on Nov. 4, 2016, patented as U.S. Pat. No. 9,825,328 on Nov. 21, 2017, and entitled “IONICALLY CONDUCTIVE COMPOUNDS AND RELATED USES”; U.S. Publication No. US-2018-0337406-A1 published on Nov. 22, 2018, filed as U.S. applicaton Ser. No. 15/983,352 on May 18, 2018, patented as U.S. Pat. No. 10,868,306 on Dec. 15, 2020 and entitled “PASSIVATING AGENTS FOR ELECTROCHEMICAL CELLS”; U.S. Publication No. US-2018-0261820-A1 published on Sep. 13, 2018, filed as U.S. applicaton Ser. No. 15/916,588 on Mar. 9, 2018, and entitled “ELECTROCHEMICAL CELLS COMPRISING SHORT-CIRCUIT RESISTANT ELECTRONICALLY INSULATING REGIONS”; U.S. Publication No. US-2020-0243824-A1 published on Jul. 30, 2020, filed as U.S. application Ser. No. 16/098,654 on Nov. 2, 2018, patented as U.S. Pat. No. 10,991,925 on Apr. 27, 2021 and entitled “COATINGS FOR COMPONENTS OF ELECTROCHEMICAL CELLS”; U.S. Publication No. US-2018-0351158-A1 published on Dec. 6, 2018, filed as U.S. applicaton Ser. No. 15/983,363 on May 18, 2018, patented as U.S. Pat. No. 10,944,094 on Mar. 9, 2021 and entitled “PASSIVATING AGENTS FOR ELECTROCHEMICAL CELLS”; U.S. Publication No. US-2018-0277850-A1 published on Sep. 27, 2018, filed as U.S. applicaton Ser. No. 15/923,342 on Mar. 16, 2018, and patented as U.S. Pat. No. 10,720,648 on Jul. 21, 2020, and entitled “ELECTRODE EDGE PROTECTION IN ELECTROCHEMICAL CELLS”; U.S. Publication No. US-2018-0358651-A1 published on Dec. 13, 2018, filed as U.S. applicaton Ser. No. 16/002,097 on Jun. 7, 2018, and patented as U.S. Pat. No. 10,608,278 on Mar. 31, 2020, and entitled “IN SITU CURRENT COLLECTOR”; U.S. Publication No. US-2017-0338475-A1 published on Nov. 23, 2017, filed as U.S. application Ser. No. 15/599,595 on May 19, 2017, patented as U.S. Pat. No. 10,879,527 on Dec. 29, 2020, and entitled “PROTECTIVE LAYERS FOR ELECTRODES AND ELECTROCHEMICAL CELLS”; U.S. Publication No. US-2019-0088958-A1 published on Mar. 21, 2019, filed as U.S. applicaton Ser. No. 16/124,384 on Sep. 7, 2018, and entitled “PROTECTIVE MEMBRANE FOR ELECTROCHEMICAL CELLS”; U.S. Publication No. US-2019-0348672-A1 published on Nov. 14, 2019, filed as U.S. applicaton Ser. No. 16/470,708 on Jun. 18, 2019, and entitled “PROTECTIVE LAYERS COMPRISING METALS FOR ELECTROCHEMICAL CELLS”; U.S. Publication No. US-2017-0200975-A1 published Jul. 13, 2017, filed as U.S. applicaton Ser. No. 15/429,439 on Feb. 10, 2017, and patented as U.S. Pat. No. 10,050,308 on Aug. 14, 2018, and entitled “LITHIUM-ION ELECTROCHEMICAL CELL, COMPONENTS THEREOF, AND METHODS OF MAKING AND USING SAME”; U.S. Publication No. US-2018-0351148-A1 published Dec. 6, 2018, filed as U.S. application Ser. No. 15/988,182 on May 24, 2018, and entitled “IONICALLY CONDUCTIVE COMPOUNDS AND RELATED USES”; U.S. Publication No. US-2018-0254516-A1 published Sep. 6, 2018, filed as U.S. applicaton Ser. No. 15/765,362 on Apr. 2, 2018, and entitled “NON-AQUEOUS ELECTROLYTES FOR HIGH ENERGY LITHIUM-ION BATTERIES”; U.S. Publication No. US-2020-0044460-A1 published Feb. 6, 2020, filed as U.S. applicaton Ser. No. 16,527,903 on Jul. 31, 2019, and entitled “MULTIPLEXED CHARGE DISCHARGE BATTERY MANAGEMENT SYSTEM”; U.S. Publication No. US-2020-0220146-A1 published Jul. 9, 2020, filed as U.S. applicaton Ser. No. 16/724,586 on Dec. 23, 2019, and entitled “ISOLATABLE ELECTRODES AND ASSOCIATED ARTICLES AND METHODS”; U.S. Publication No. US-2020-0220149-A1 published Jul. 9, 2020, filed as U.S. application Ser. No. 16/724,596 on Dec. 23, 2019, and entitled “ELECTRODES, HEATERS, SENSORS, AND ASSOCIATED ARTICLES AND METHODS”; U.S. Publication No. US-2020-0220197-A1 published Jul. 9, 2020, filed as U.S. applicaton Ser. No. 16/724,612 on Dec. 23, 2019, and entitled “FOLDED ELECTROCHEMICAL DEVICES AND ASSOCIATED METHODS AND SYSTEMS”, U.S. Publication No. US-2020-0373578-A1 published Nov. 26, 2020, filed as U.S. applicaton Ser. No. 16/879,861 on May 21, 2020, and entitled “ELECTROCHEMICAL DEVICES INCLUDING POROUS LAYERS”, U.S. Publication No. US-2020-0373551-A1 published Nov. 26, 2020, filed as U.S. applicaton Ser. No. 16/879,839 on May 21, 2020, and entitled “ELECTRICALLY COUPLED ELECTRODES, AND ASSOCIATED ARTICLES AND METHODS”, U.S. Publication No. US-2020-0395585-A1 published Dec. 17, 2020, filed as U.S. applicaton Ser. No. 16/057,050 on Aug. 7, 2018, and entitled “LITHIUM-COATED SEPARATORS AND ELECTROCHEMICAL CELLS COMPRISING THE SAME”, U.S. Publication No. US-2021-0057753-A1 published Feb. 25, 2021, filed as U.S. applicaton Ser. No. 16/994,006 on Aug. 14, 2020, and entitled “ELECTROCHEMICAL CELLS AND COMPONENTS COMPRISING THIOL GROUP-CONTAINING SPECIES”, U.S. Publication No. US-2021-0135297-A1 published on May 6, 2021, filed as U.S. applicaton Ser. No. 16/670,905 on Oct. 31, 2019, and entitled SYSTEM AND METHOD FOR OPERATING A RECHARGEABLE ELECTROCHEMICAL CELL OR BATTERY”, U.S. Publication No. US-2021-0138673-A1 published on May 13, 2021, filed as U.S. applicaton Ser. No. 17/089,092 on Nov. 4, 2020, and entitled “ELECTRODE CUTTING INSTRUMENT”, U.S. Publication No. US-2021-0135294-A1 published on May 6, 2021, filed as U.S. applicaton Ser. No. 16/670,933 on Oct. 31, 2019, and entitled “SYSTEM AND METHOD FOR OPERATING A RECHARGEABLE ELECTROCHEMICAL CELL OR BATTERY”; U.S. Publication No. US-2021-0151839-A1 published on May 20, 2021, filed as U.S. applicaton Ser. No. 16/952,177 on Nov. 19, 2020, and entitled “BATTERIES, AND ASSOCIATED SYSTEMS AND METHODS”; U.S. Publication No. US-2021-0151830-A1 published on May 20, 2021, filed as U.S. application Ser. No. 16/952,235 on Nov. 19, 2020, and entitled “BATTERIES WITH COMPONENTS INCLUDING CARBON FIBER, AND ASSOCIATED SYSTEMS AND METHODS”; U.S. Publication No. US-2021-0151817-A1 published on May 20, 2021, filed as U.S. applicaton Ser. No. 16/952,228 on Nov. 19, 2020, and entitled “BATTERY ALIGNMENT, AND ASSOCIATED SYSTEMS AND METHODS”.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present disclosure is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A system for forming components of an electrochemical cell, comprising:
a plurality of nozzles comprising at least a first nozzle having a first tip, a second nozzle having a second tip, and a third nozzle having a third tip, wherein the first tip of the first nozzle, the second tip of the second nozzle, and the third tip of the third nozzle are colinear along an x-axis;
a substrate positioned proximate the plurality of nozzles, wherein the first tip, the second tip, and the third tip occupy different positions along a z-axis such that each tip has a different height with respect to the substrate; and
a roll-to-roll handling system proximate the substrate configured to move the substrate relative to the plurality of nozzles.

2. A method for forming components of an electrochemical cell, the method comprising:
spraying from a first nozzle a first plurality of particles onto a substrate;
forming a first layer comprising the first plurality of particles on the substrate;
moving the first layer from a first position to a second position; and
spraying from a second nozzle a second plurality of particles onto the first layer, wherein a first tip of the first nozzle and a second tip of the second nozzle occupy different positions along a z-axis such that each tip has a different height with respect to the substrate,
wherein the first and second pluralities of particles are the same or different.

3. The system of claim 1, wherein a first spacing between the first nozzle and the second nozzle is adapted and arranged to reduce turbulence between the first nozzle and the second nozzle compared to a second spacing less than the first spacing.

4. The system of claim 1, wherein the spacing between the first tip of the first nozzle and the second tip of the second nozzle is greater than or equal to 1 times a diameter of the first nozzle and/or less than or equal to 2 times the diameter of the first nozzle.

5. The system of claim 1, wherein the plurality of nozzles comprises a de Laval nozzle, a rocket nozzle, a conical nozzle, and/or a slit nozzle.

6. The system claim 1, further comprising a first hopper coupled with the first nozzle, a second hopper coupled with the second nozzle, and/or third hopper coupled with the third nozzle.

7. The system claim 1, wherein each nozzle of the plurality of nozzles is configured to rotate about a point.

8. The system claim 1, wherein one or more battery containers is positioned on the substrate.

9. The method of claim 2, further comprising fusing at least a portion of the first plurality of particles.

10. The method of claim 2, further comprising fusing at least a portion of the second plurality of particles.

11. The method of claim 2, further comprising depositing the second plurality of particles on the first layer to form a second layer such that a gradient of the first plurality of particles and the second plurality of particles is formed, wherein the first plurality of particles increases or decreases along an axis extending from a surface of the first layer to a surface of the second layer.

12. The method of claim 2, wherein the method is performed in a container comprising a base and at least one sidewall.

14. The method of claim 2, wherein the first plurality of particles comprises a cathode active material.

15. The method of claim 2, wherein the first plurality of particles comprises a current collector material.

16. The method of claim 2, wherein the second plurality of particles comprises a separator and/or a solid-electrolyte material.

17. The method of claim 2, wherein the second plurality of particles comprises an anode active material or a current collector material.

18. The method of claim 2, further comprising spraying a third and/or fourth plurality of particles and/or forming a third and/or fourth layer.

19. The method of claim 18, wherein the third plurality of particles comprises an anode active material.

20. The method of claim 18, wherein the fourth plurality of particles comprises a current collector material.
